(19) United States
(12) Patent Application Publication
(10) Pub. No.: US 2025/0199667 A1
(43) Pub. Date: Jun. 19, 2025

(54) System & Method of Tracking Data & Providing a Digital Logbook & Database

(71) Applicant: 4F Applied Technologies, LLC, Tallahassee, FL (US)

(72) Inventor: Utpal Dutta, Tallahassee, FL (US)

(73) Assignee: 4F Applied Technologies, LLC, Tallahassee, FL (US)

(21) Appl. No.: 19/069,073

(22) Filed: Mar. 3, 2025

Related U.S. Application Data
(63) Continuation-in-part of application No. 17/102,323, filed on Nov. 23, 2020, now Pat. No. 12,242,462.
(60) Provisional application No. 62/939,306, filed on Nov. 22, 2019.

(51) Int. Cl. G06F 3/04842; G06F 3/04817; G06F 3/0482; G06F 9/451

(52) U.S. Cl. CPC G06F 3/04842; G06F 3/04817; G06F 3/0482; G06F 9/451

(57) ABSTRACT

Systems and methods for electronically tracking a client's location, activities, and behaviors for use in a closed environment. A database stores inputted information and may be encrypted. The user enters notes that include active notes, forms, or manually entered data. The notes can be entered by SMS, talk-to-text or by typing and can include files, pictures, videos, or the like. Each note is displayed to the user in a list of forms that can be queried. An active note allows an administrator to require certain fields be entered by the user. The active note can automatically attach data collected passively in an ongoing manner through input devices throughout the closed environment that are related to the task that the active note represents.

### CROSS-REFERENCES TO RELATED APPLICATIONS

This application is a continuation-in-part application of U.S. application Ser. No. 17/102,323 which lists the same inventor and remains pending.

### STATEMENT REGARDING FEDERALLY SPONSORED RESEARCH OR DEVELOPMENT

Not Applicable

### MICROFICHE APPENDIX

Not Applicable

### FIELD

This invention relates to a computer-implemented method and system to assist businesses with keeping track and logging data. Specifically, the present invention comprises a method and system for allowing a user to track their duties and activities, while linking said data to an online database.

### BACKGROUND

The need for a digital log and tracking database system occurs mainly in organizations that employ many people and/or are responsible for mainlining records for many people, such as in correctional institutions. Traditionally, activities, behaviors, and locations of individuals in an organization are tracked via a manual logbook, as illustrated in FIG. 1. The figure illustrates the logbook of a correctional officer, but the reader will appreciate that the present invention may be used in any type of environment requiring logging of activity and location of individuals. User 24 uses writing instrument 26 to create logbook entries 28 on manual logbook 22. This process is tedious, requiring user 24 to manual write logbook entries 28 using writing instrument 26. Because of the excess time this process takes up, user 24 may put off entering logbook entries 28 into manual logbook 22 until many minutes or hours after the particular task is done, leading to data entry error because of the time that has past.

This current process takes a substantial amount of time and effort, requiring the user to manually log each event while it is fresh in their memory in order to obtain the most accurate logbook entries. This takes valuable time away from the job at hand and is also subject to human error. Educational institutions, correctional institutions, or other similar institutions are required to track many individuals' behaviors at once. In order to do so, the entity must collect accurate data on individuals relating to both the environment and the individual's interaction with and response to the environment. The accuracy and thoroughness of the data is important and there are criteria that must be met in order to provide a functional behavioral assessment and currently track one's location at any given time. However, these entities are usually ill-equipped to accurately collect and track this data. Therefore, the data may be skewed, incomplete, or inaccurate.

For the foregoing reasons, there is a need for a computer implemented method and system having an electronic logbook and activity tracker, with cloud-based storage. Additionally, it is advantageous for the system to collect passive data, including the collection of a client or user location that can be tracked via biometric assistance such as finger and eye scans, and/or a personalized Quick Response (“QR”) code. It is also advantageous to be able to categorize the information stored into various forms, share information stored, and attach pictures, videos, and/or video recordings to the electronic logbook.

### SUMMARY

The present invention is directed to a computer implemented system and method for tracking and logging a user's location, activities, and behaviors in a controlled environment. The computer-implemented method and system provides a computer program for use on a computer usable medium (client server) which is capable of accessing a database server or other storage medium having a computer readable code. The system is completely paperless, and pairs with various devices including mobile devices for increased accessibility. The database server includes a series of linked databases that make up the computer program product. A user will log in to the system by providing a unique user ID and password, which will match to the user table database. The log in can also be accomplished by linking to an external device that the user is carrying or wearing, such as a smart watch or an NFC tag (near-field communication technology). NFC is a wireless radio communications standard that is similar to RFID technology but only work at a maximum range of about 4 inches. It is in this manner that a user having an NFC tag would be required to be in close proximity to the mobile device to log in, thereby providing their credentials in a secure manner. The user table database is capable of providing the user with a user specific sub-set of data. This sub-set of data may be data that was entered by that user or written to the database by another user. Further, the system is fully configurable with different types of short-range wireless technology or radio standards. For example, the system is capable of being configured to use Bluetooth, Wi-Fi, NFC, Dedicated Short-Range Communications, etc.

When a user logs in, the mobile application prompts a user to record data through a series of graphical user interfaces which provide inputs for a user to select. Preferably, a user will use the system through a mobile device having a mobile application, such as a mobile tablet. However, the reader will appreciate that a web application could also be used. The near real-time data that is recorded by a user will be related to the actions, behaviors, and locations of individuals being observed or the user their self. The present method provides a means for recording and storing the data that is inputted by a user or other input device along with the capability of presenting that data in an organized manner.

The user or other individuals' locations may be tracked via other input devices such as cameras, unique QR codes, or biometric assistance such as finger or eye scanners. Thus, the system is preferably used in conjunction with scanning devices or cameras at a site. Specifically, a camera may capture the location of a user the moment the user scans his QR code to enter a room. Thereafter, the database will store the footage displaying the location of the user because the QR code prompted the system to collect said footage. The footage can be linked to an entry (or note) that the user inputs. Alternatively, a user may use an eye scanner or fingerprint scanner at a particular location, prompting the system to collect the location of said user at a given time and date and store such information into the database.

Apart from recording locations, an electronic logbook is included in the system, allowing a user to input subjective information about activities and behaviors of other individuals, such as inmates. This “virtual note-taking” may be done through typing, script-to-text, swipe-to-text, and voice-to-text. The electronic logbook allows the user to categorize information while also including metadata regarding such information. For example, the user can input notes and also attach photographs, videos and forms. The metadata behind the attachments is also included (e.g. the date a photograph was taken, the type of camera used, owner of the camera, etc). The user can also modify information or notes using highlights, strike-through, copy and paste, and various font colors. This system allows for comprehensive collection of data with minimal to no training of the user.

Configurable emoticons are available to categorize data, trigger rules, monitor and capture timed activities, meet specified standards and integrate with other outside functions such as visitor logs. A visual history may also be available via tagging functionality which is done automatically by facial recognition or manual tagging. The database may include task functions that may be inputted by the user, including travel time, medications, bed/cell checks, and other automated report generation upon completion of the particular task. The user may be able to enter notes and complete certain tasks via short message service (“SMS”) text while also adding metadata such as location automatically. There is automatic date and time stamping for all activities to maintain data integrity.

A master facility view allows viewing of data from all sub-facilities from a single view, filtering based on notes, user screens, and/or sub-facility. The system can assist in aggregating data to identify trends. For example, the system may identify that more errors occur in dosing medication when it is distributed to inmates at the end of a nurse's shift. If that is the case, the prison may benefit from a different schedule—e.g. by distributing medication at the start of a nurse's shift.

Field level security is available with encryption. Offline data entry and functions are available as well. Finally, the system allows for a user to share information inputted with other users on the system. The user's profile is pin protected, and all files shared are password protected, providing for additional data integrity.

### BRIEF DESCRIPTION OF THE DRAWINGS

FIG. 1 is a perspective view, showing a prior art logbook in use;

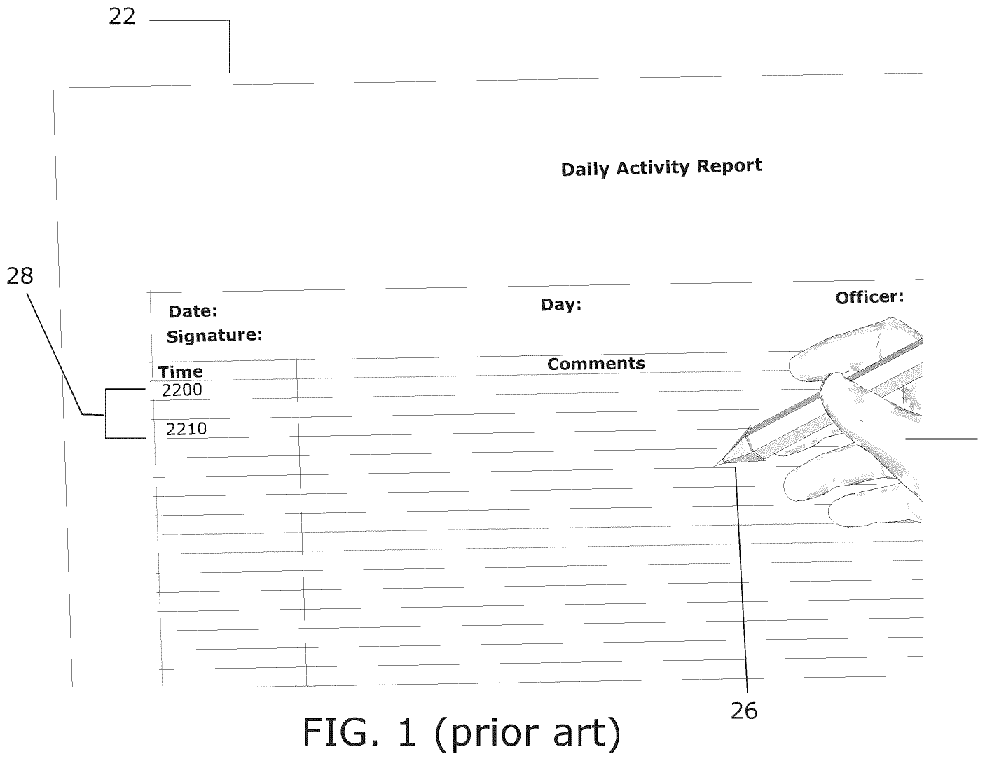

FIG. 2 is a schematic view, showing a simplified depiction of the site at which, the present system and method is implemented;

FIG. 3 is a schematic view, showing some of the hardware components of the present system and method;

FIG. 4 is a schematic view, showing the hardware components of the present system and method in one embodiment;

FIG. 5 is a flow chart, showing the present computer program product and method;

FIG. 6 is a screen shot, showing a version of the summary screen of the user interface provided by the present system;

FIG. 7 is a screen shot, showing a user interface of the compiled graphical stored data provided by the present system;

FIG. 8 is a screen shot, showing the report entry page of the present system;

FIG. 9 is a screen shot, showing the user database of the present system;

FIG. 10 is a screen shot, showing the facility database of the present system;

FIG. 11 is a screen shot, showing the permission page for the interface of the present system;

FIG. 12 is a screen shot, showing the general task page of the interface of the present system;

FIG. 13 is a screen shot, showing the note input page of the interface of the present system;

FIG. 14 is a screen shot, showing a view of notes inputted into note input page of the interface of the present system.

FIG. 15 is a screen shot, showing a pop-up screen with emoticons (or active notes) displayed on the interface of the present system;

FIG. 16 is a screen shot, showing the note input page of the interface of the present system;

FIG. 17 is a screen shot, showing a pop-up screen to enter facility information associated with a note for the present system;

FIG. 18 is a screen shot, showing the note input page of the interface of the present system;

FIG. 19 is a screen shot, showing a pop-up screen to enter a user verification pin of the interface of the present system;

FIG. 20 is a screen shot, showing a pop-up screen to enter a verification or signature on the interface of the present system;

FIG. 21 is a screen shot, showing the note input page of the interface of the present system;

FIG. 22 is a screen shot, showing the task creation page of the interface of the present system;

FIG. 23 is a screen shot, showing a pop-up screen to view upcoming tasks and/or to elect to create a new task;

FIG. 24 is a screen shot, showing an overview of the individuals (clients) monitored on the present system;

FIG. 25 is a screen shot, showing the pop-up window showing a series of locations or activities to select from on the present system;

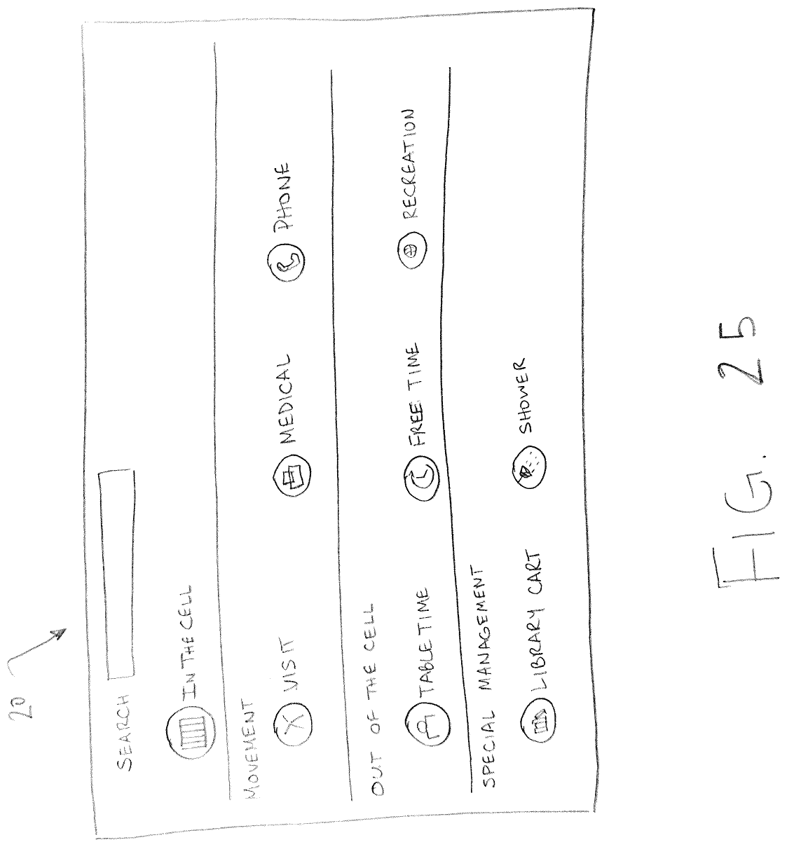

FIG. 26 is a screen shot, showing the individuals (clients) on the move on the present system;

FIG. 27 is a screen shot, showing the QR code of the present system and method;

FIG. 28 is a screen shot, showing a profile of an individual (client) monitored using the interface of the present system;

FIG. 29 is a screen shot, showing an exemplary task entry screen for a bed check on the present system;

FIG. 30 is a screen shot, showing an exemplary bed check report on the interface of the present system;

FIG. 31 is a screen shot, showing a fire drill log on the interface of the present system;

FIG. 32 is a screen shot, showing a home visit log on the interface of the present system;

FIG. 33 is a screen shot, showing a discharge form on the interface of the present system;

FIG. 34 is a screen shot, showing an incident form on the interface of the present system;

FIG. 35 is a screen shot, showing the devices that are active in the current system;

FIG. 36 is a screen shot, showing the user locations of the present system;

FIG. 37 is a screen shot, showing the locations of the subjects monitored using the present system;

FIG. 38 is a screen shot, showing the rules page on the interface of the present system;

FIG. 39 is a screen shot, showing the forms page on the interface of the present system; and

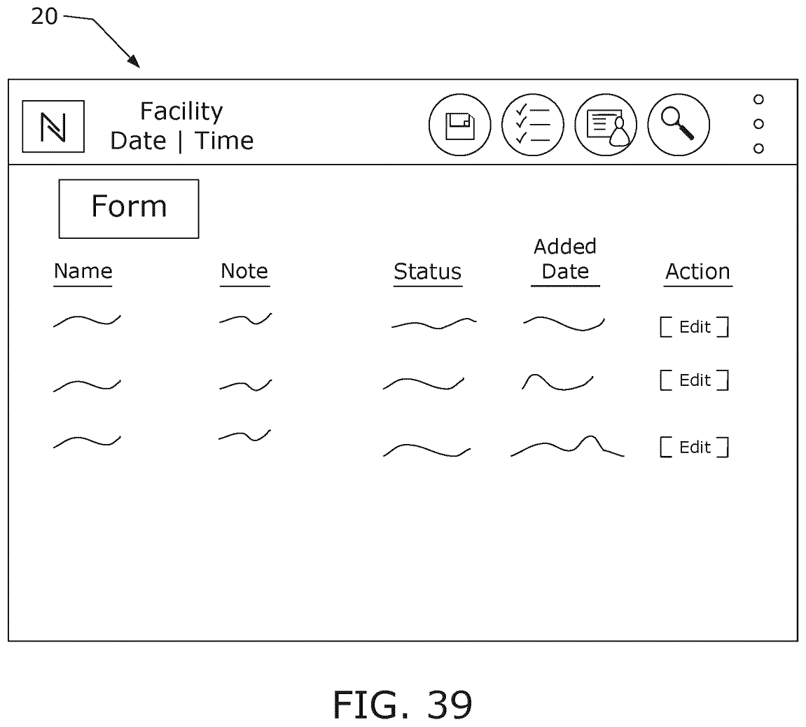

FIG. 40 is a screen shot, showing the pop-up window user interface displayed when active note icon is selected.

### REFERENCE NUMERALS IN THE DRAWINGS

10 site
12 input device
14 mobile device
16 fingerprint scanner
18 iris eye scanner
20 graphical user interface
22 manual logbook
24 user
26 writing instrument
28 logbook entry
30 QR reader
32 server
34 computing device
36 processor
38 video camera
40 database
42 microphone
46 cellular service provider
48 wireless router
50 laptop
52 computer
54 time entry area
55 text entry area
56 tablet
58 QR code
60 display
62 pie chart
64 note log
66 tool bar
68 bar graph
70 trending table
72 report page
74 emoticon
76 note
78 rule
80 form
82 task
84 profile
86 active note icon
88 client icon
90 location icon
92 facility icon
94 document icon
96 user icon
98 comment icon
100 standards icon
102 highlighter icon
104 attachment icon
106 pop-up window for active notes
108 font color icon
110 pop-up window for facility
112 attachment review icon
114 save icon
116 task icon
118 pop-up window for task creation
120 pop-up window for task list
122 add button
124 tag saved note icon
126 strike out icon
128 temperature sensor
130 moisture sensor
132 search icon
134 text color icon
136 strikethrough icon
138 share icon
140 tier
142 total
144 out
146 moving
148 locator icon
150 roster icon
152 medical icon

### DETAILED DESCRIPTION

The present method and system is a computer program product and method for allowing a user to input, store and compile data including the location of a person, log notes, file reports, behavior and biographical information of different persons while managing a group of persons in a controlled environment, such as a correctional institution or a school.

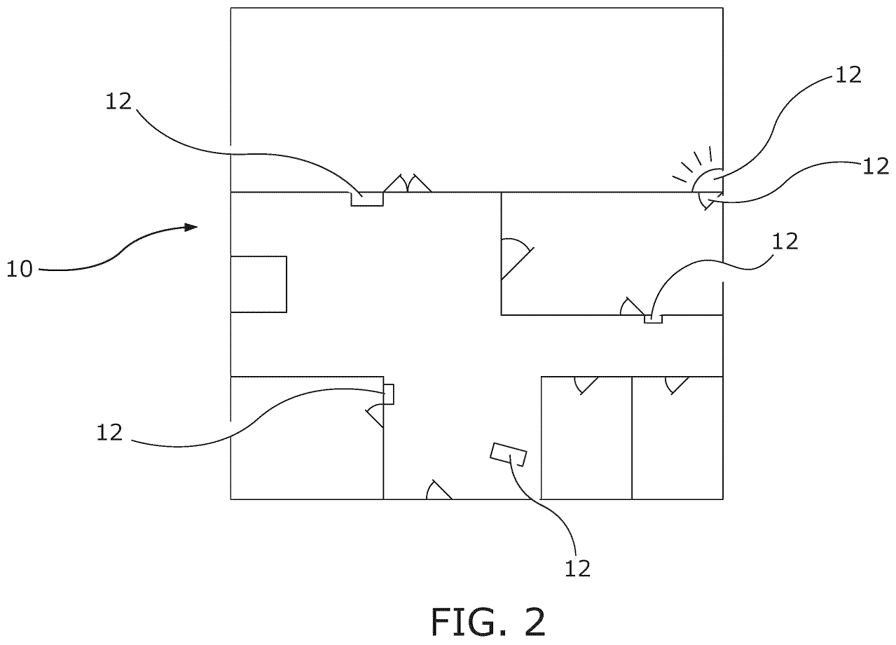

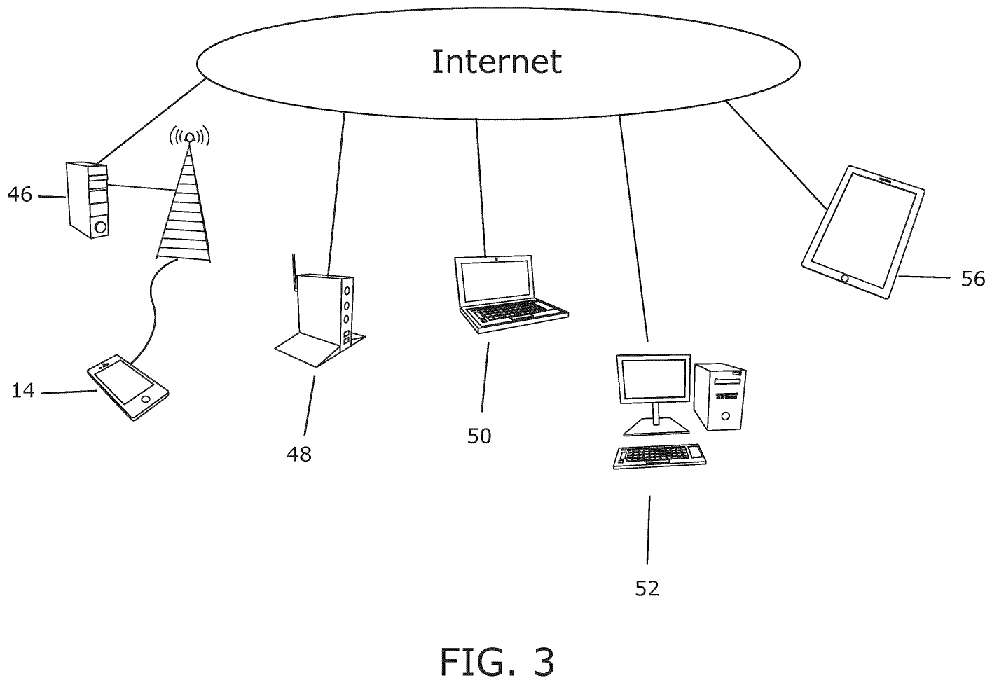

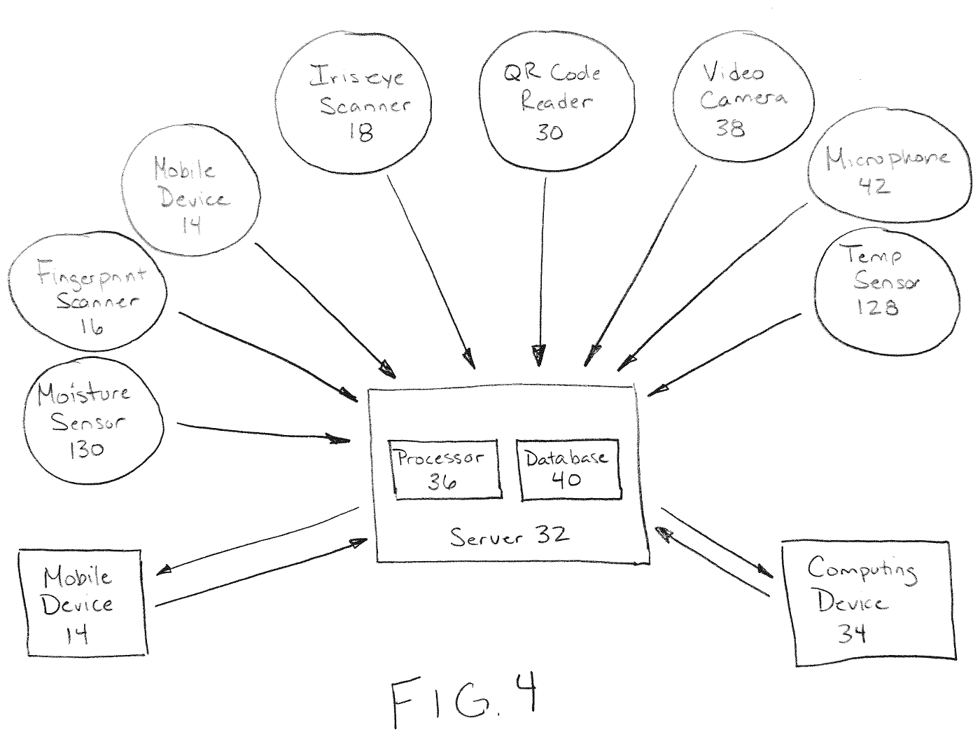

FIG. 2 illustrates the controlled environment, such as a correctional institution or a school, in a schematic view. A series of input devices 12 are used in and around the environment or site 10 which act to collect data (for purposes herein, this data collected is referred to herein as second set of data). Input devices 12 can be any type of input device that is capable of collecting, tracking and transferring data. For example, as shown in FIG. 4, fingerprint scanner 16, mobile device 14 (e.g. tablet, smart watch, etc.), iris eye scanner 18, QR code reader 30, video camera 38, temperature sensor 128, moisture detector 130, and microphone 42 act as input devices. Additionally, a user can utilize a mobile device 14 to collect or input data regarding an individual's activities in near real time. FIG. 3 shows input devices 12 connected to the internet via a wireless router 48 (a “communication link”). The reader will appreciate that input devices 12 could be connected to the internet via hardwire (another “communication link”) or any other known method. The input devices 12 collect first and second sets of data and transmit that data to a database on a server 32. The server could be a local or remote server. Therefore, the data could be collected and transferred to a local (on premises) physical server or a remote (virtual) server on a cloud computing platform via the internet (through any communications link).

FIGS. 3 and 4 depict exemplary hardware that may be used in connection with the present system and method. Communications are preferably conducted over the internet since this will give the broadest possible access to portable devices. However, the reader will appreciate that the present system and method has an offline data entry function, allowing for certain functions while not connected to the internet with the ability to show the last facility the user was logged in to. A user may access the present system and method through the internet via mobile device 14 through cellular service provide 46 or via “Wi-Fi” through wireless router 48. Using mobile device 14, a user also has the ability to enter notes or particular task types via short message service (“SMS”), speech-to-text (“STT”), electronic mail or other input mechanisms. Such data collected via SMS or STT will add metadata—such as the user name, the user's location and the time and date of entry—automatically into the database to be stored in connection with the note. Wireless router 48 may also provide internet access to laptop 50 and tablet 56 such that the user may access the graphical interface of the present system and method via laptop 50 or tablet 56. Desktop computer 52 may also be used to access the present invention via the internet. While not shown, the reader will appreciate that a user has the ability to electronically export or physically print forms and information from the present system and method using any device described above with the ability to print or communicate with a conventional printer. FIG. 4 shows input devices such as fingerprint scanner 16, iris eye scanner 18, QR code reader 30, video camera 38, temperature sensor 128, moisture sensor 130, and microphone 42 interacting with server 32 on which computer program product is executed (computer readable code is capable of being executed on server or server system). A processor 36 and database 40 reside on server 32. A user can interact with the system utilizing a mobile device 14 or a computing device 34. The reader will appreciate that mobile device 14 preferably has a mobile application that is capable of providing a user interface that simplifies the input and output of data from server 32. Database 40 provides data in the form of stored information collected by input devices. The user may access information stored in database 40 via computer program product and view, edit, or add notes or additional information.

One important input device, a mobile device 14, includes a mobile application which prompts a user to record a first set of data through a series of graphical user interfaces which provide inputs for a user to select. As explained herein, this first set of data is related to the actions and behavior of individuals (clients, inmates, students, patients, etc.) who are observed in a controlled environment, such as prisons, schools, hospitals, and the like. The mobile application links the username to any note entered. This is accomplished by requiring the user to log in, such as entering a pin number, pairing the user's smartwatch with the mobile device 14, or using biometric features (e.g. fingerprint or facial recognition). The present method provides a means for assessing the data, inputting the data, and providing a presentation of the data in a modified form by way of charts, graphs, and compiled data.

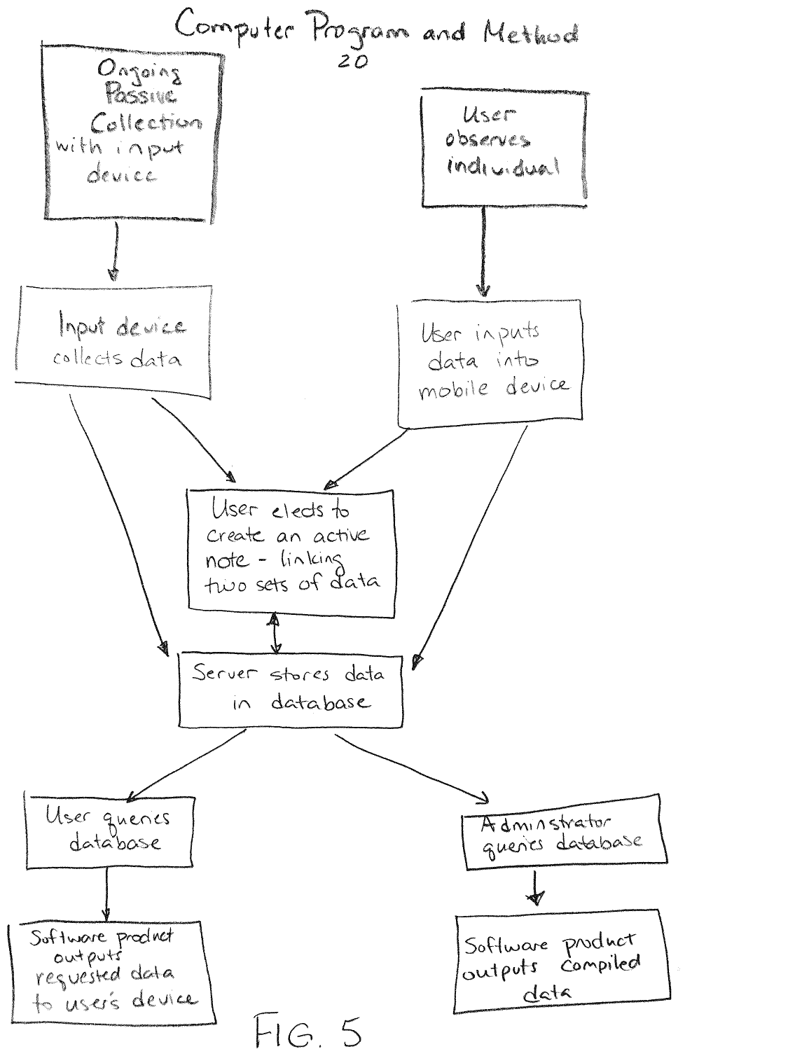

FIG. 5 illustrates the steps of the present computer program product and method. While the present method is illustrated in a series of steps, the reader will appreciate that the steps may be executed in a number of different variations. In the present embodiment, input device 12 collects data in an ongoing manner. This data is passively collected throughout the day. For example, if there is a video camera, the camera footage is being collected all day by the system and stored for some set period in a database. Ultimately a user, can link a portion of that passively collected data, as a second set of data, to an active note. For example, an inmate may enter a room by scanning a QR code on a QR reader 30 at the door to the room. The QR reader 30 collects the time and date that the inmate entered the room and the door through which the inmate entered. This data is transmitted to server 32 where it is stored in a database. At some point in time, a user may wish to enter an active note, such as an inmate altercation. The user could begin entering the active note selecting the note (or task) for critical incident. A first set of data is collected by observation and input through a mobile application. For example, the first set of data may include the type of incident, the location and the inmate(s) involved. Importantly, a second set of data, consisting of ongoing passive data collected throughout the day can be linked to the active note. For example, the system may compile the activities of a specific inmate on the date of the incident and link that data to the active note. The second set of data may consist of data that is requested by the user (by engaging in a query of the database) or system generated (such as if the active note has a setting to collect the current temperature from a temperature sensor in the location entered by the user). The system would attach the second set of data to the active note. Thus, when viewing the active note, a user could see the incident data and the inmate's activity around the site 10 on the date of that incident. In another example, a user may observe and document an inmate's behavior or activity at a specific time and enter that first set of data using a mobile application on the user's mobile device as a note. The mobile application has interfaces which allow for simple inputs to collect data, as described further herein. Once the first set of data is entered into the mobile device, the device sends that first set of data to the server where it is stored in the database. Note that although the description refers to a first and second set of data, there is not sequential basis to the data. The terms “first” and “second” are only used to differentiate data collected based on input by a user (first set of data) and data collected on an ongoing “passive” basis whether based on an individual's (in this case client, such as student or inmate—also referred to as “observed individuals”) interaction with an input device or data collected by the input device based on the environment (such as a temperature sensor) (second set of data). Additionally, at any time the database can be queried by a user for any notes, including active notes (those that may include passively collected data), that are saved in the system. Users can also search the database to query data that is not associated with a note, such as data collected passively or for data inputted by a user (both first and second sets of data) that is not necessarily associated with a note. Similarly, an administrator can run queries for data on a database to analyze compiled data. The compiled data may reveal patterns that may assist with managing the site. For example, compiled data may show that medical professionals on site are more likely to make a mistake in administering medication at the end of their shift. The site manager may decide to administer medication at the start of the medical professional's shift to avoid such mistakes.

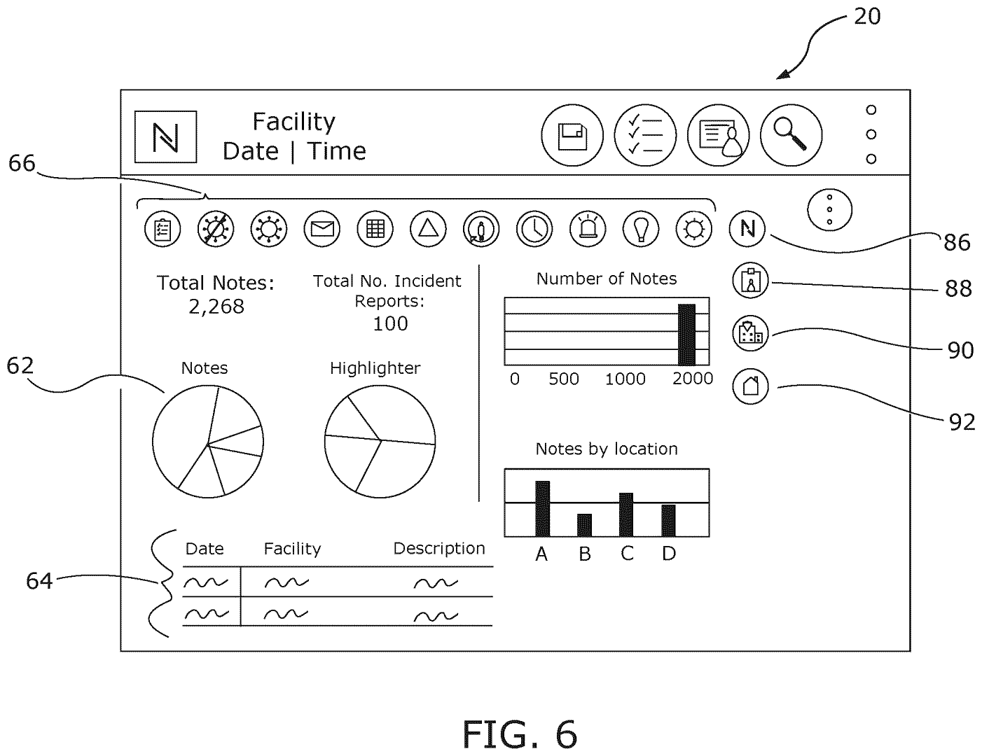

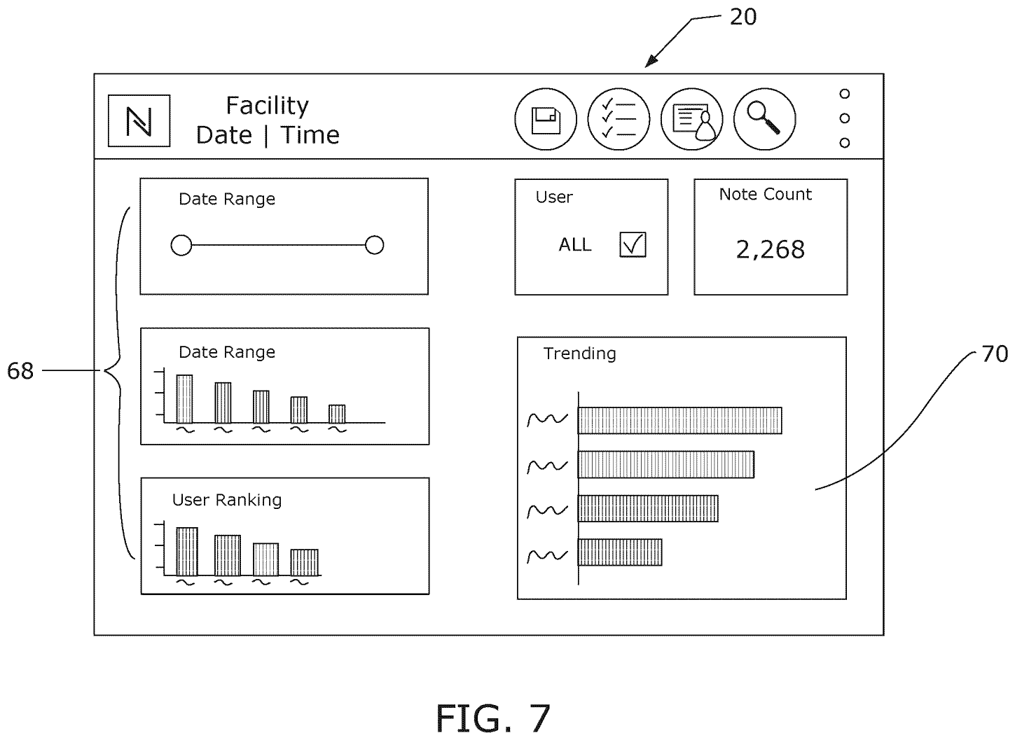

A series of screen shots describe the implementation of the present system and method. FIGS. 6-7 illustrate screen shots of the present method in one embodiment after a user, such as an administrator, logs into the present computer program product showing exemplary graphical user interfaces 20. The reader will appreciate that a user can utilize any login method. For example, a user could have a unique username and password, or a user may need further identification, such as a unique pin for a facility. Likewise, the facility itself could have a login username and password and each user may have a unique pin. Additionally, the user may login by using a smartwatch, NFC tag or biometric data.

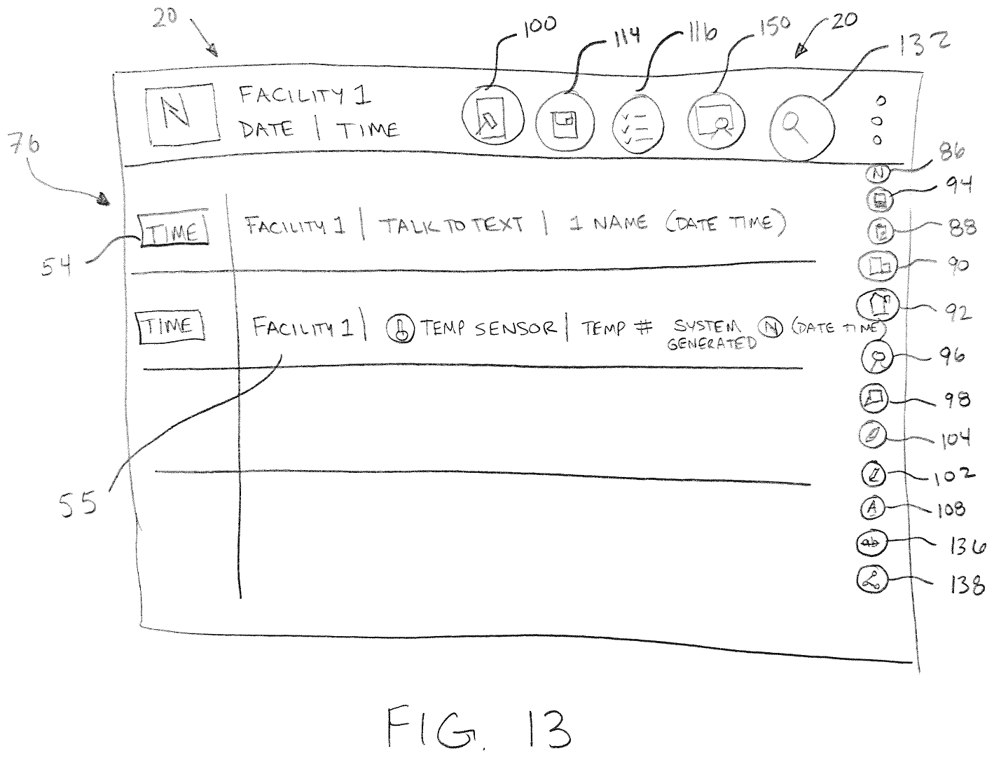

As shown in FIGS. 6-7 graphical user interface 20 includes tool bar 66 and several icons including, but not limited to, active note icon 86 (to enter an active note), client icon 88, location icon 90 and facility icon 92. As will be further described herein, upon entry of a note 76 (shown and described in FIG. 13), a user can easily tag items by utilizing icons (86, 88, 90, 92). Another set of icons at the top of the screen allows a user the ability to easily navigate to different pages, as described herein. A series of icons 66 are also located on the screen and allow the user access to different webpages.

An administrative user can view various graphical representations that have been created using the data from the user's activity on computer program product's graphical user interface 20 (visual metadata). This allows a user to read, recognize, and process information that has been collected in order to optimize use of the present system and improve overall function. For example, pie chart 62 displays that relative time the user spends on any one task, gathered from the metadata collected when user uses computer program product. Graphical user interface 20 of computer program product also displays the total number of notes and incident reports made by the user. Note log 64 displays the most recent notes taken by the user by date, facility, and description. FIG. 6 displays various bar graphs 68, illustrating the present system's ability to display a user's activity based on a particular date range. This page may be navigated to using tool bar 66 or other function (such as a drop-down list). FIG. 6 also depicts trending table 70 in this example, displaying various tasks performed by a user from most frequent at the top to least frequent. These dashboard (overview) screen depictions are exemplary, and many other variations of a dashboard screen may be implemented. Likewise, graphical user interfaces 20 of the present program can vary from page to page and are also exemplary, as many other designs can be utilized. Further, different users may receive different graphical user interface based on their individual access permissions. FIG. 7 illustrates additional overview information on a graphical user interface 20, including a trending table 70 and bar graphs 68 for the user to view.

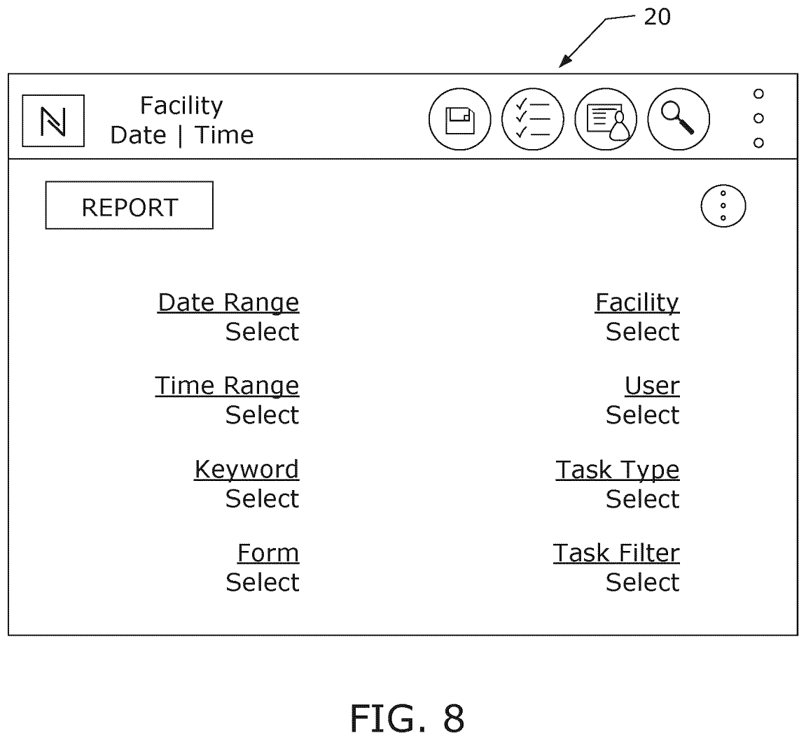

A user may use tool bar 66 to navigate to the report page 72, as shown in FIG. 8. Report page, represented by graphical user interface 20, provides a place for the entry of information to filter collected data and run a report based on that data over a set period. The user can select a date range, facility, form, task or other identifier. It is in the manner that a user could filter through data in an aggregate format and run a report to identify or show trends. For example, a user may wish to identify how frequently a certain task is completed in one facility and compare that data to a second facility. The reporting function allows a user a simple way for the user to view the data collected and stored in the database in an organized manner.

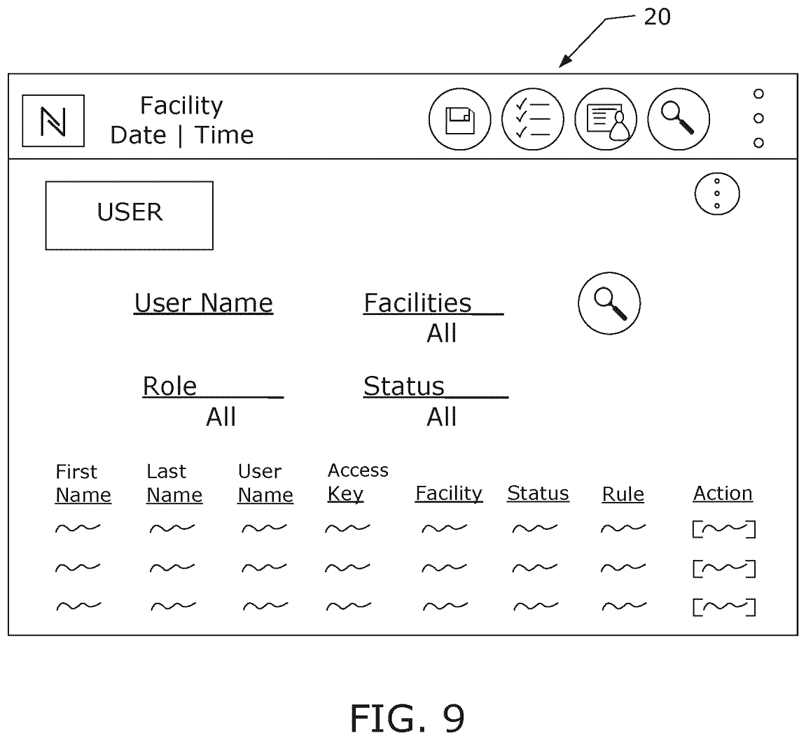

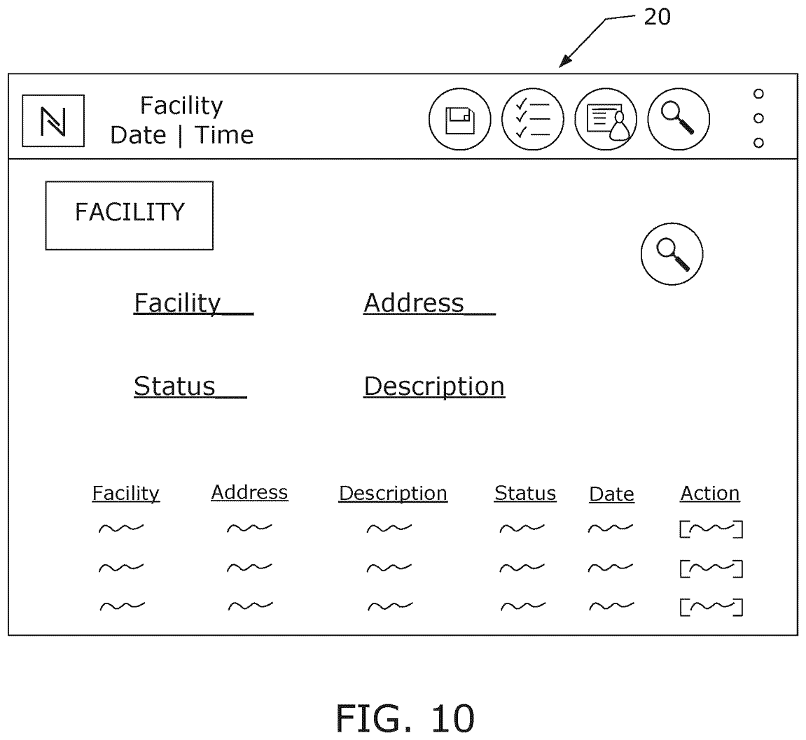

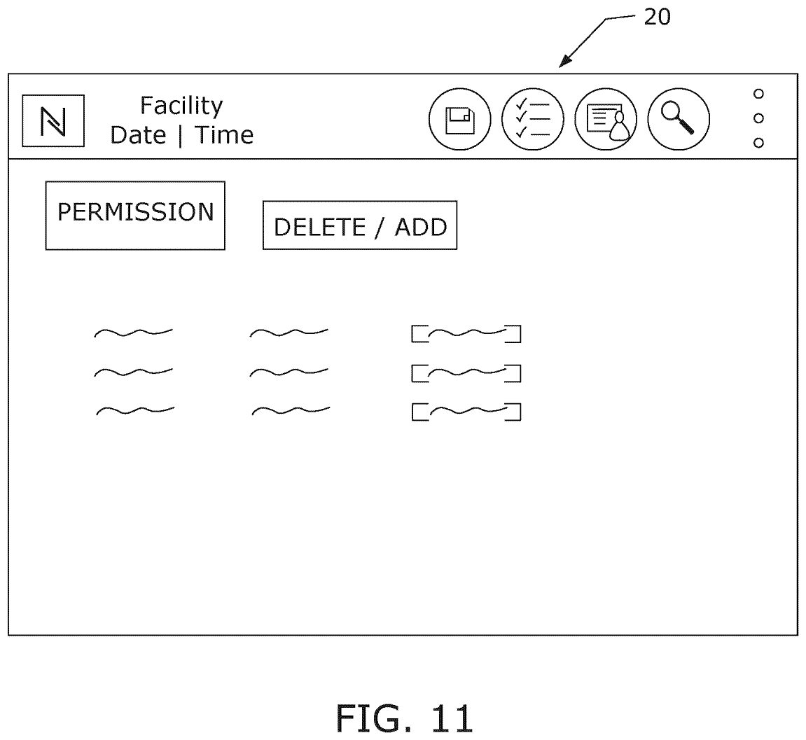

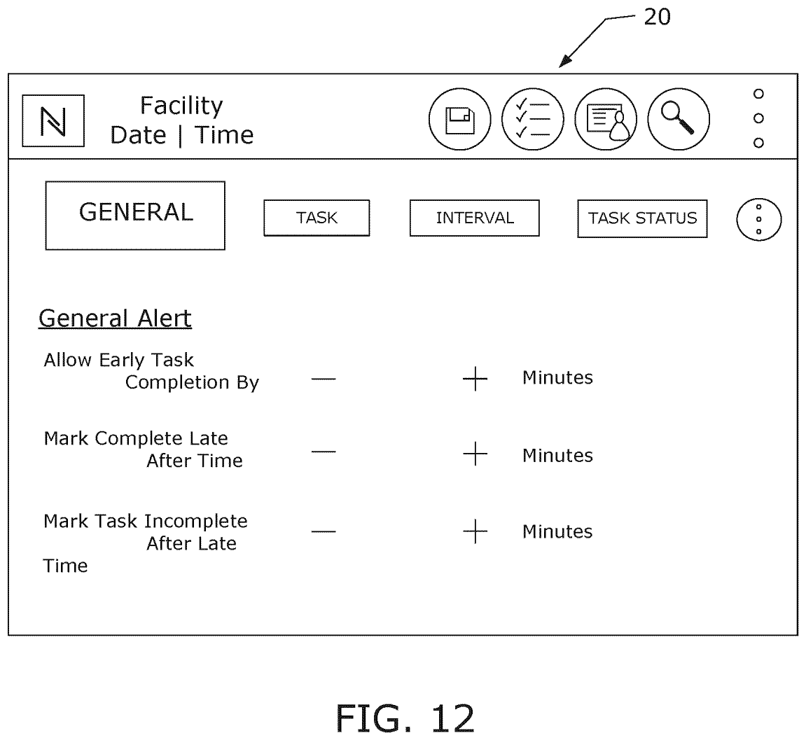

FIG. 9 shows one graphical user interface 20 of computer program product that lists users authorized in the current program, while FIG. 10 shows the facilities equipped with computer program product in a graphical user interface 20. Each page may be navigated to using tool bar 66. In some instances, these pages (along with those depicted in FIGS. 11 and 12, at least) can only be accessed by an administrator, with security credentials. As shown in FIG. 9, a list of users at a specific facility or all facilities can be viewed and edited by an administrator on this page. Access keys can be reset, facilities or multiple facilities can be designated to the user and a role can be assigned. FIG. 10 allows an administrator to view and edit data from each facility (or all facilities) in a single view. The graphical user interface 20 of the present computer program product may be used by a hospital, prison or correctional institution, a school, or any other like facility that must monitor various individuals at any given time.

FIG. 11 shows the graphical user interface 10 of permissions page, which is used by the facility itself and may be navigated to using tool bar 66. The permissions page allows an administrator to determine which users and/or sub-facilities have access to which aspects of computer program product.

FIG. 12 illustrates a graphical user interface 20 for a general page, which may be navigated to using tool bar 66. This page allows an administrator to set parameters for task completion and notifications. For example, a user may designate the ability to complete an “early task” sixty minutes in advanced from when the task was designated to be complete. This figure is exemplary of the advantage of the present system and method.

FIG. 13 displays one graphical user interface 20 of the main page of the computer program product that the user uses and interacts with when collecting data. Generally, computer readable code will be executing a set of instructions on a mobile computing device (and on the server system as a whole) for the user to interact with on the same. A typical user will interact with this note page on a frequent basis by collecting and inputting data through notes 76. Computer program product allows users to take comprehensive notes 76 efficiently and in an organized manner. A note 76 includes any information or data inputted in an entry. Note 76 can include an entered active notes 86, system generated data and login information. When a note 76 is completed (or as data is entered), the note 76 is saved and provided to the central database. The computer program product can report on the data in the note 76, along with other data aggregated together. User can enter a note 76 in a number of different ways—this encourages users to take notes 76 and increases the efficiency of entering pertinent data.

In one example, to begin a note 76, user clicks on any point on a row (either time area 54 or text area 55). The reader will appreciate that user can use any known method of starting note 76 or entering data into note 76. The time area 54 is automatically populated with the current time. The date is also automatically associated with the note 76. A user can then begin to type the text of the note 76 that the user wishes to enter in text area 55. In the alternative, a user can enter a note 76 via text message (“SMS”) or speech-to-text (“STT”) using mobile device 14, electronic mail or other input mechanisms. Data collected via SMS or STT will add metadata—such as the user's name, the user's location and the time and date of entry—automatically into the database to be stored in connection with the note. Data can also include health data collected from a smartwatch, such as the user's number of steps, temperature, heart rate, etc. This can be especially useful in a task such as a suicide watch, which can actively monitor an observed individuals vital signs. A series of icons are available for the user to quickly tag each note. For example, a user could select the client icon 88, location icon 90 or facility icon 92 to connect the note to a certain client, location or facility.

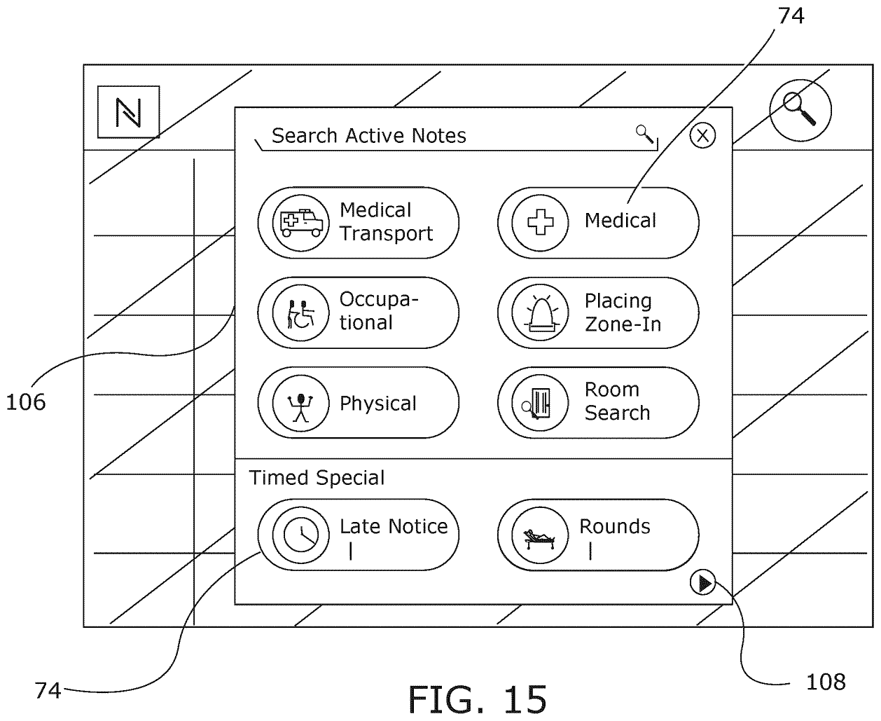

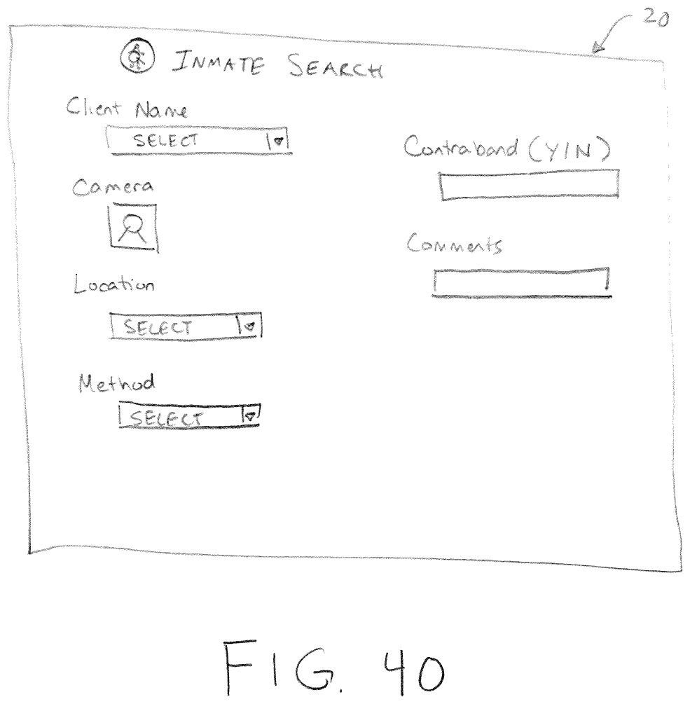

If the user wishes to enter an active note, the user can right click on the time area 54 or text area 55. An active note icon 86 will be visible. When the user clicks on the active note icon 86, the user can begin an active note. By clicking on active note icon 86, the user will be presented with a series of predetermined images with associated text (a “task”) in a pop-up window for active notes 106, to easily complete the description of the note, as shown in FIG. 15. These active notes are characterized by emoticons 74 (and represent individual tasks to be performed) and are easy, efficient ways for the user to consistently categorize (and therefore better organize) all notes. Here, the user may select an emoticon 74 that relates to a specific task. In one example, the user selects the inmate search icon. That selection may trigger the user to input additional information based on an administratively created required fields, as shown in FIG. 40. These fields can relate to specific standards (such as legal requirements, facility guidelines or preferences). Therefore, user may receive a prompt after selecting the inmate search icon to select an inmate name and location from a drop down menu. The required fields often have a drop down menu that assists in entering the data quickly and accurately. For example, if the user is required to enter the inmate name, the inmate name field may include a drop down menu with all of the inmates housed at the specific location that the user is searching. The user may be required to take a picture of the inmate. If the user indicates that contraband is found, the user may be prompted and required to take a picture of the contraband. This ensures data is confirmed and entered contemporaneously with the search increasing accuracy and efficiency.

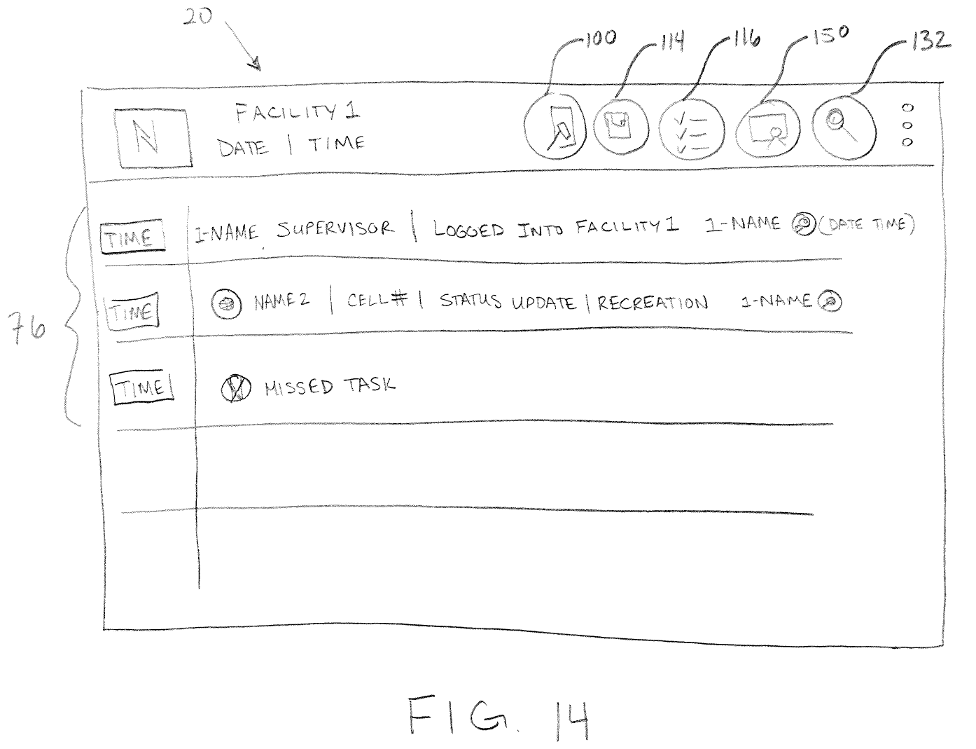

Returning to FIG. 15, the present system and method has a section that includes a series of special active notes. The special active note section at the bottom of the pop up window and includes an option for “late notice” and “rounds.” Another option could include a suicide watch. An administrator or user can set up the required fields and include specific drop down options for the user's convenience. Once set up, a user can easily complete a suicide watch note. The user selects the emoticon for the suicide watch task, the user will be prompted to enter information to include the name of the inmate, the type of watch, the date, and other pertinent information. The selections for the required fields and drop down options may be based on state or federal laws, codes or regulations (in other words, sets of standards). As an example, a regulation may require a guard monitor and report on an inmate that is placed on a critical suicide watch every thirty (30) minutes. The drop down menu can include the option for “critical watch.” Once the other fields are complete, the system can prompt the user to check and report information every thirty (30) minutes. If the user fails to report the information for any given interval, the system will generate a note that reports that a task was missed and further information regarding the task. An example of the note 76 generated for a missed task is shown in FIG. 14. This feature ensures that users are provided timely reminders, accurate information and specifies when a task is missed for purposes of complying with reporting requirements.

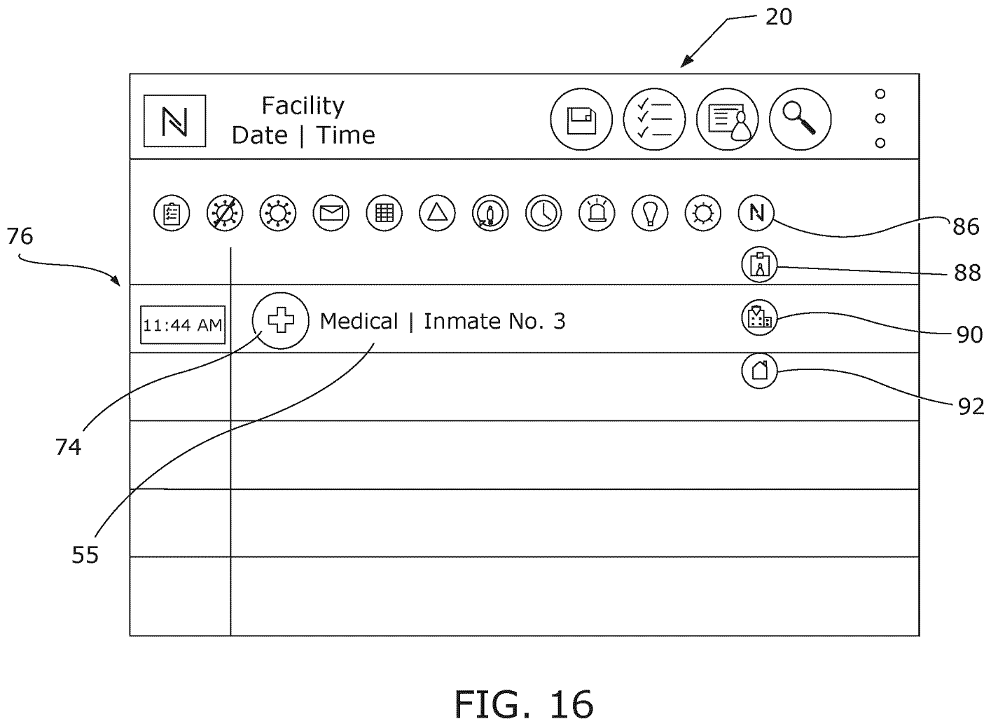

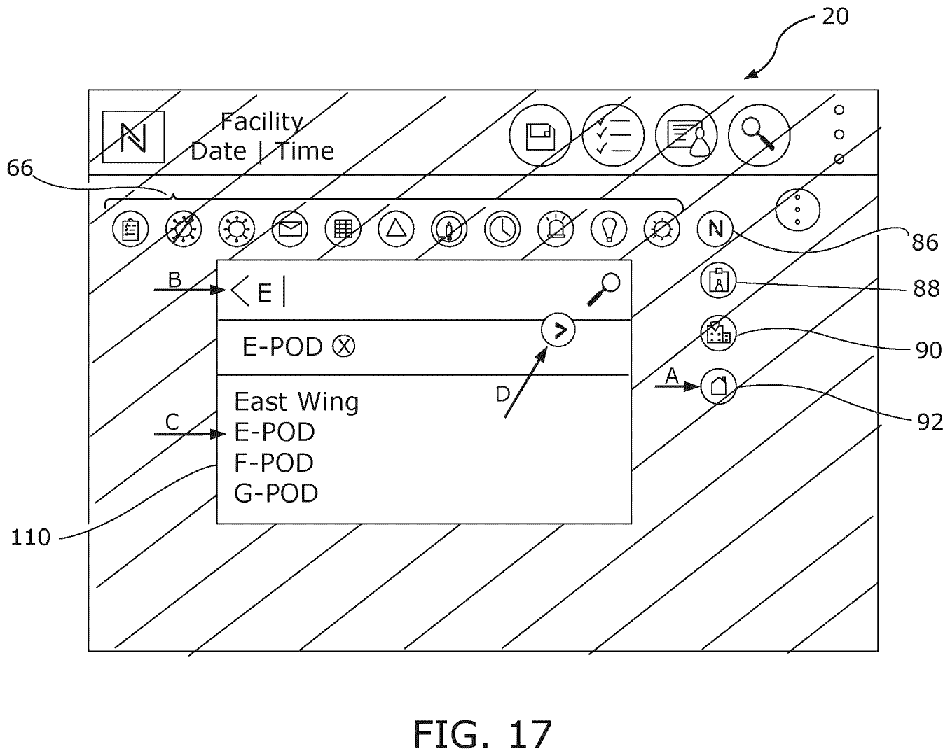

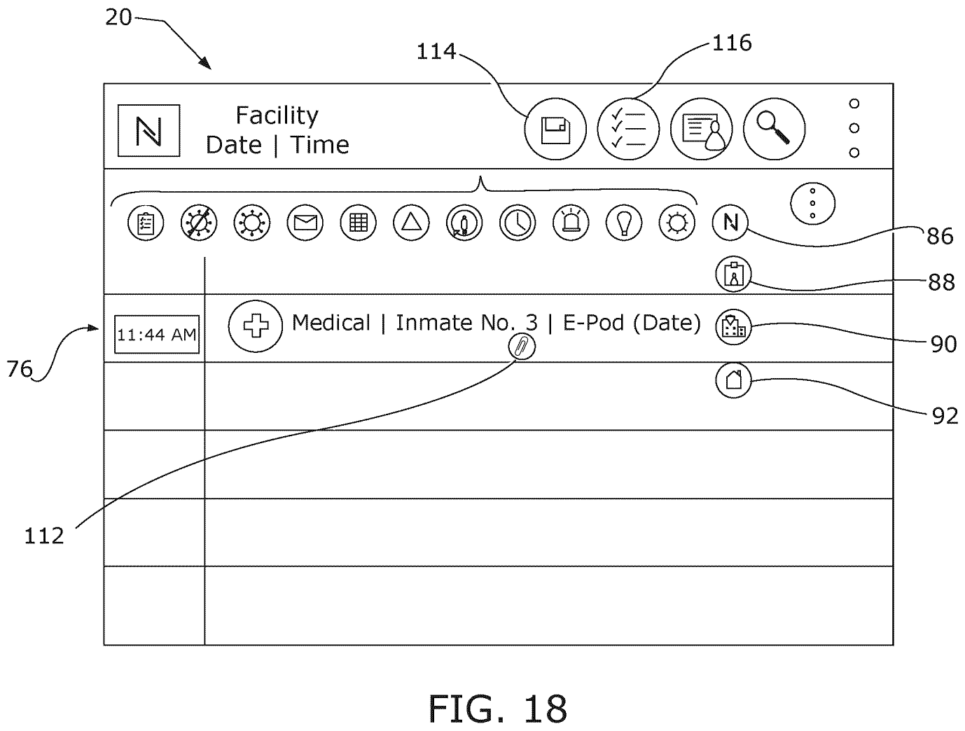

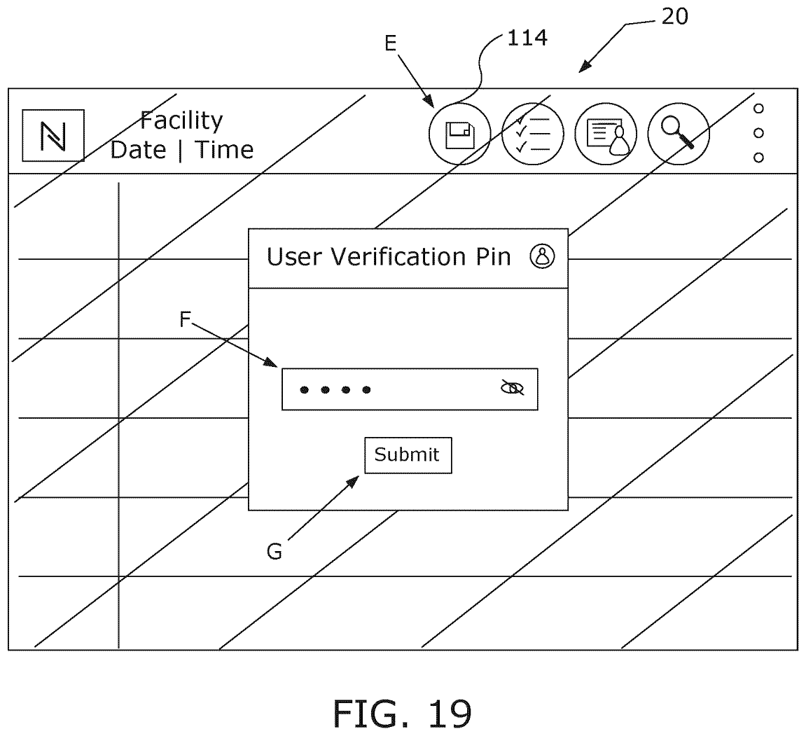

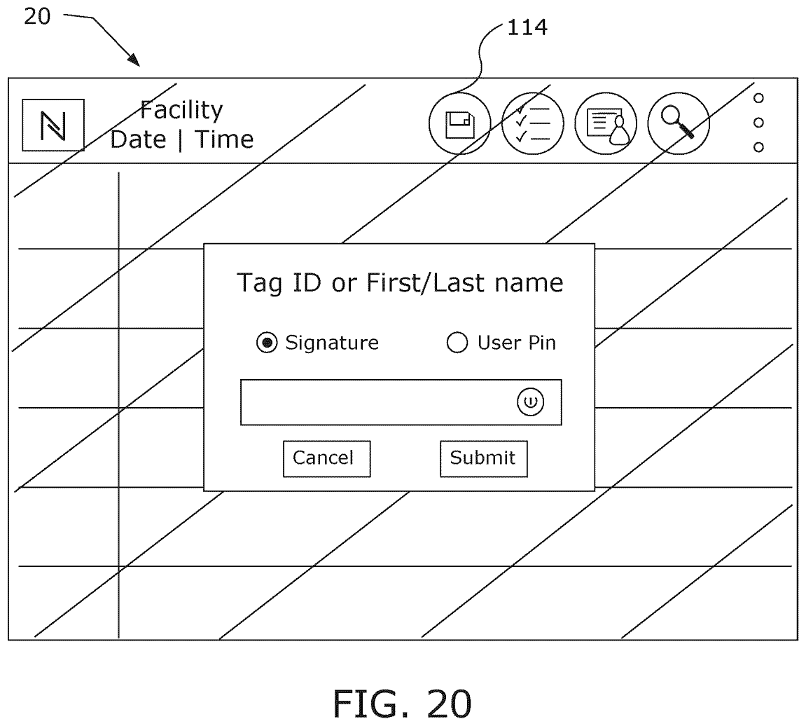

The active note emoticons 74 can, in some instances, allow the notes 76 to collect sensitive data but hide that data while still indicating the type of note that was entered. In the illustrated example, the user selects “medical” icon and submits using the submit icon 108. FIG. 16 illustrates the view for the user after the “medical” icon is selected and submitted. The text area 55 is automatically populated with the emoticon 74. The user may also have entered data upon selecting the “medical” icon and receiving a series of drop down menus to ensure all information necessary was collected. Therefore, with less than 3-4 clicks, the user has efficiently entered data and a description. If the user wishes to enter additional data that was not previously collected, the user can click on, for example, the client icon 88, which will similarly display a pop-up window with a searchable list of clients (in this case, inmates). Assuming this data was not previously entered after the user entered the active note, the user can search for and select a client. The clients can also be sorted by most recent, alphabetical or location (or any other known means). Once selected and submitted, the client can be displayed in the note 76, as shown in FIG. 16. This process can be repeated for the location icon 90 and facility icon 92. For example, as shown in FIG. 17, the user can easily select the facility by clicking on the facility icon 92 (arrow A), thereby displaying a pop-up window for facility 110 containing a searchable facility database. The user begins to enter text in the search area (shown by arrow B), and the list auto populates, (here, showing the options in alphabetical order). The user can select the facility, shown as arrow C, and once selected, submit (shown as arrow D). The user will be brought to a screen showing the full note 76, with the inputted information, as shown in FIG. 18. While data can be added to the note 76 using the facility icon 92, client icon 88 or other icons, most active notes will include the necessary information once the active note icon 86 is selected, rather than require the user to enter the information in the active note and navigate back to the facility icon 92 on the note page. The reader will appreciate that as notes 76 are added, they will appear on the same screen so that the user can view the notes 76 entered on that day (the “note page”). To submit the note, the user clicks on the save icon 114 (action shown by arrow E), a pop-up window appears to enter a verification pin (arrow F), as illustrated in FIG. 19. Once entered the user can click submit (arrow G). The program may also requests a tag ID or signature, as illustrated in FIG. 20. The user is required to verify note 76 prior to saving the note entry. This can be done through a signature or a user pin that is unique to the user. In the alternative a smartwatch or wristband that identifies the user can connect via Bluetooth®, or other similar connection, to confirm the user's credentials and identify the user entering the note. This provides yet another security feature of the present system, allowing for data integrity. For example, now, only completed and verified notes are submitted to the central database.

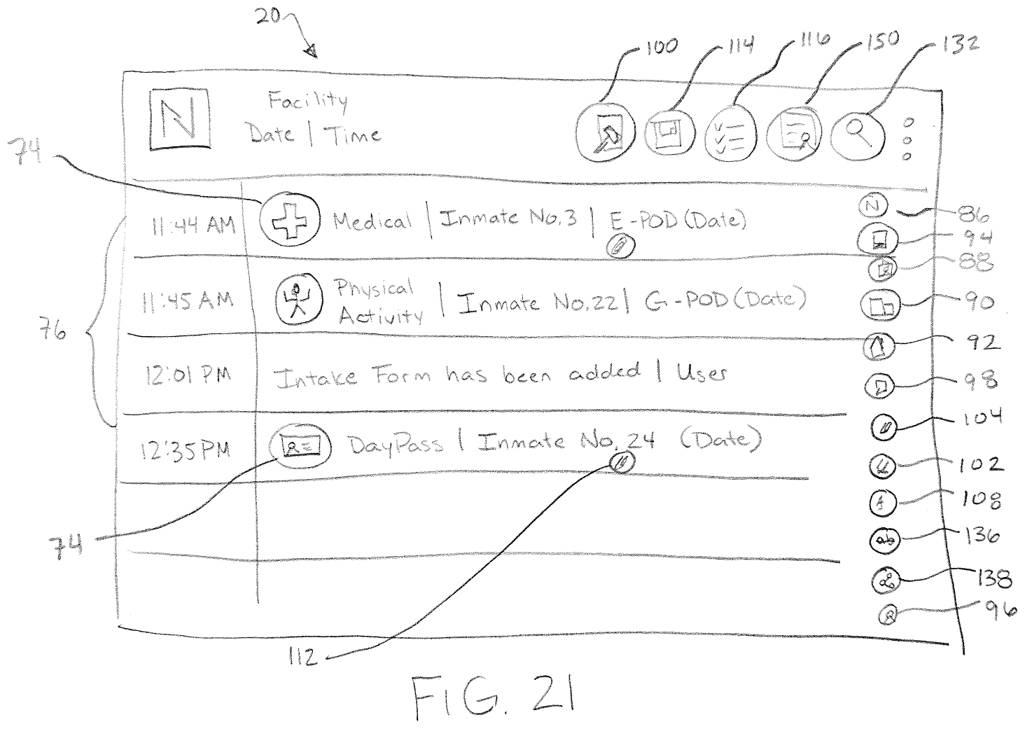

FIG. 21 illustrates a screenshot of several notes 76 that have been entered by a user throughout the day. The view illustrates several notes with attachments, images and emoticons. The notes typically have an “active note,” characterized by emoticon 74, however it is possible that there will be notes 76 that only include an added form or an audio recording, for example. Notes 76 can also be edited prior to verification. For example, the highlighter icon 102 provides a highlight function allowing a note 76 to be highlighted, the text color icon 109 provides a text color function allowing the user to change the color of the text in any note 76, the strikethrough icon 136 allows a user to strikethrough text in a note and the share icon 138 allows a user to share a note via text, electronic mail or other means. Additionally, the user will be able to see if the notes 76 have been submitted and verified by viewing the list. The program can provide a notification for unsubmitted or incomplete notes, further decreasing the chance of error in compiling information in a facility. The notes 76 will also show the user if there is an attachment, such as an image, recording, form, etc. attached to the note 76. The attachment icon 112 can be clicked to view the attachment for review. Notes 76 may have various attachments attached or tagged to them. Forms 80, as discussed in detail below, may be configured and completed within the program and attached to notes 76 along with pictures, videos, and/or voice recordings (attached or transcribed). This feature allows for more integrative notetaking than prior art logbook entries 28. Using the present system and method, a user can categorize information, trigger business processes, and track information, which all allow for extensive and accurate data collection with minimal training to users.

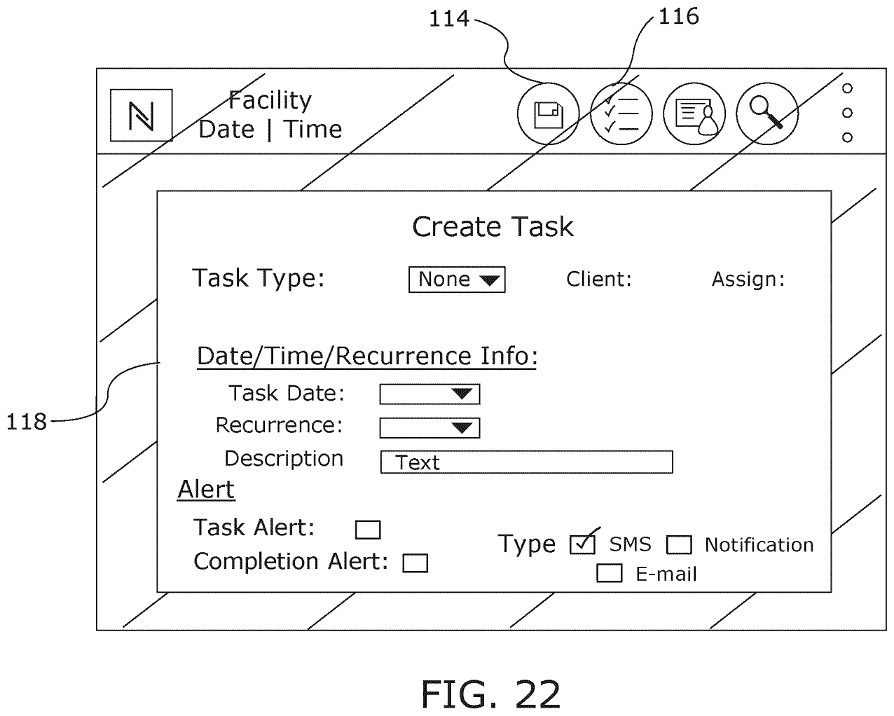

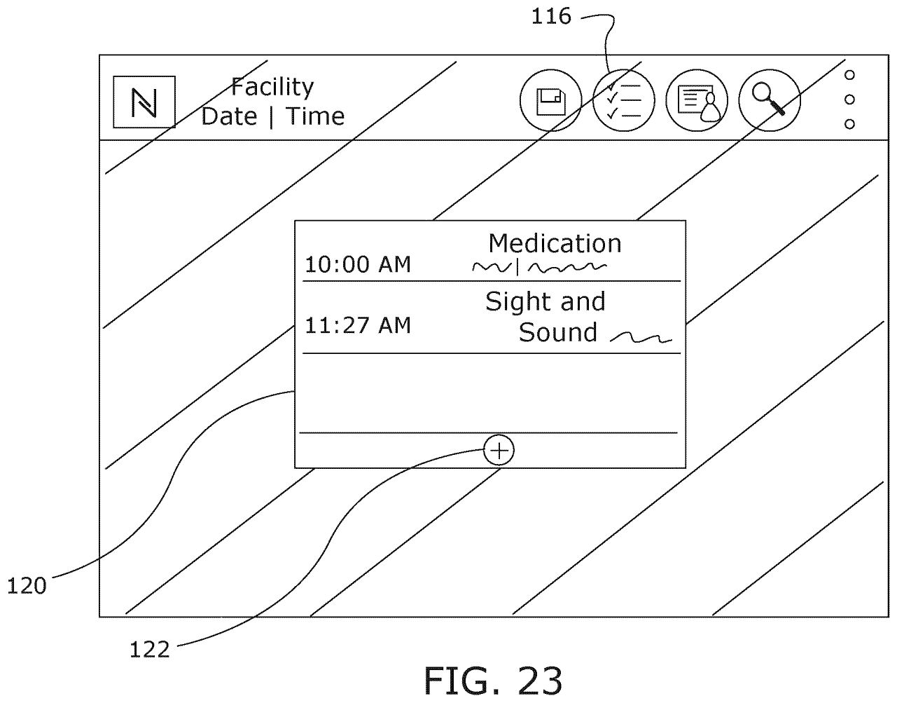

An active note can be prompted by the creation of a recurring active note task. The following figures discussed illustrate several exemplary active note tasks that users can create. On the main note page, illustrated in FIG. 21, the user can select the create task icon 116 to begin to create a task. FIG. 22 illustrates the creation of recurring task 82. Task 82 may be many activities that a user may be required to complete, such as a bed check, approved travel, medication administration, etc. Task 82 entry provides the user with the advantage of tagging an activity in a streamlined and organized manner. Each task 82, created in a pop-up window for task creation 118, has a type, a date and time, a recurrence ability, a description, and an alert type, should the user desire one (however, any “data entry point” can be used). Once task 82 is created it appears on a list of active tasks that pop-up window for task list when the user clicks on the active note icon 86 or the task icon 116, as shown in FIG. 23. Tasks 82 can also be set to recur on specific days and therefore used repeatedly without recreating the task 82. For example, if the user creates a task 82 for a user to provide medication every Monday to a specific client, the program will alert the user of the task 82 every Monday (and appear on the list of tasks 82 to complete), prompting the user to complete the task 82. Upon completion of task 82, an automated report is generated and attached to the completed task 82, creating metadata stored in computer program product 20 and appearing on the list of notes on the note page (shown in FIG. 21). Note that new tasks can be added by selecting the add icon 122 (“+”) at the bottom of task list 120.

In one example, a user may be required to administer medication. The user will select the “medication” task (shown in FIG. 23) to begin the task. A recurring alert may be useful since medication is generally required to be administered at particular times during the day. The alert may be provided via text to the user (email or other). The user will open the task and view a series of easy entry icons to select from. For example, the task may require an image capture to show the prescription administered. Once complete the user selects complete and a signature pop-up appears for the user to either enter a signature or a user pin to submit the task (similar to FIG. 20). For bed or cell checks, task 82 will be titled “bed check” or “cell check.” In this task type, a user will configure the facility definition of bed or cell, and visual recognition may be used to confirm the location of said bed or cell. The user may also attach pictures under task 82 in this example to further bolster the data provided and confirm location of the bed or cell.

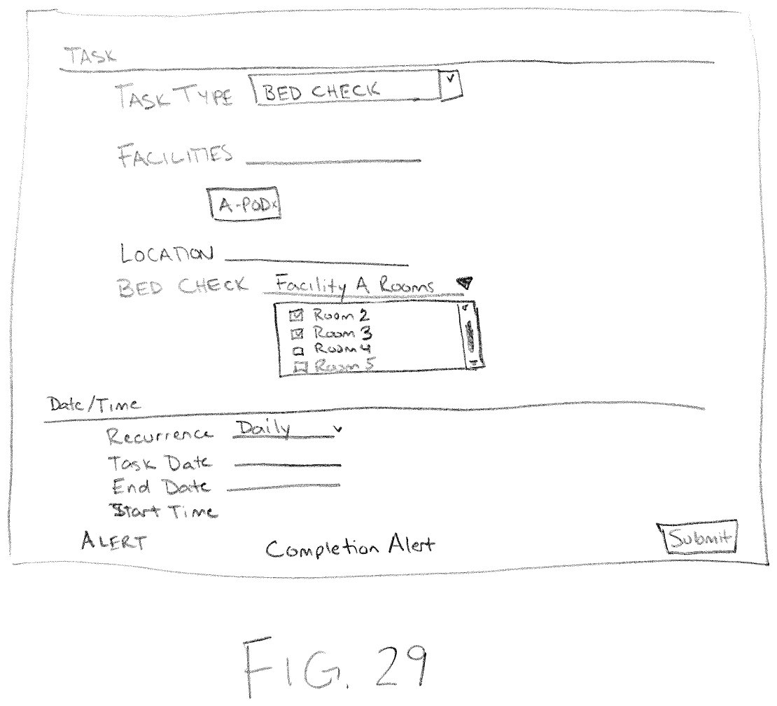

In another example, the user elects to create a recurring bed check task, as illustrated in FIG. 29. This function is particularly useful in facilities such as a hospital or a correctional institution, in which the subjects being monitored are required to be in bed at a time and location. The task entry menu provides drop down selections to enter facility information, location, date, time and recurrence information. The task entry system simplifies the process. For example, when the administrator selects the facility and location, the rooms in that facility and location are auto-populated in a list, wherein the list includes a box next to each room that can be selected to appear in the task and prompt a room check. For example, a room may not be occupied and therefore may not require a room check—the administrator can only select the occupied rooms to populate in the task. Once the task is set up, the task will be provided to the user at the required time and date. The user can also select the task through the active note icon 86 and each room that requires checking will appear in the note. Once checked the user can quickly and efficiently complete the bed check, entering details when necessary. A signature of the user is required for added security and accuracy of reporting.

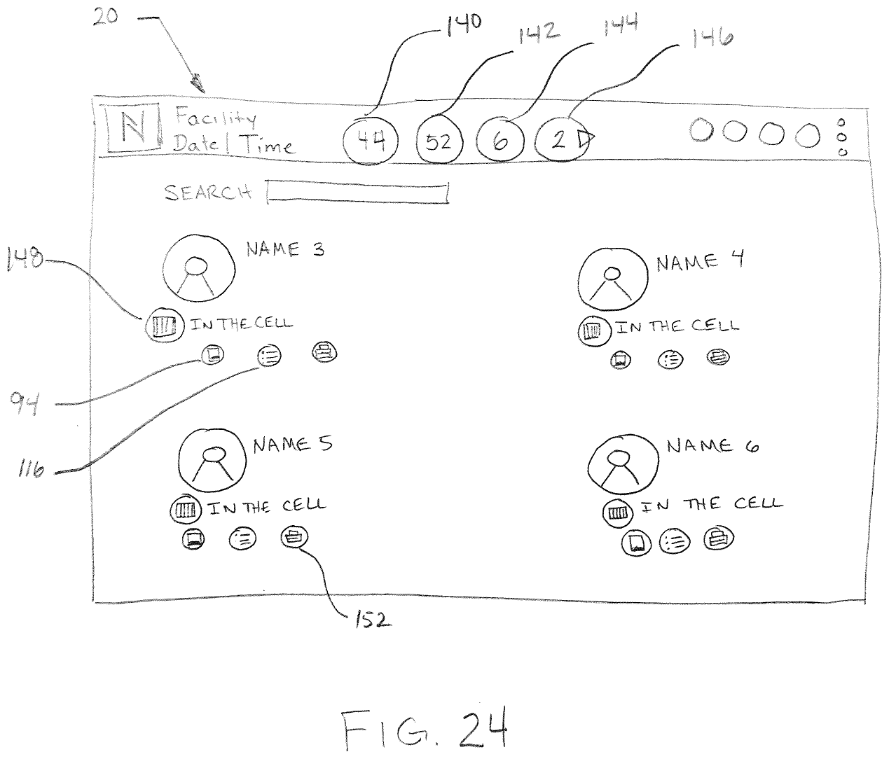

The present system also allows for a comprehensive and efficient way to view and track clients (in this case, inmates) in specific locations or facilities. FIG. 24 illustrates a graphical user interface 20 for a client page. This view is available to the user by selecting the roster icon 150 at the top of the notes page, shown in FIG. 21. Returning to FIG. 24, the client page (roster) shows a user interface 20 that includes a series of clients with information regarding each client. Each client is an inmate assigned to a certain location. The page includes interactive icons at the top of the page showing a summary of the active location of the clients. Four circles with numbers in each circle (each number is color coded) respectively represent the number of inmates in their tier (tier 140), the number of inmates total (total 142), the number of inmates out of their tier (out 144) and the broken circle indicates the number of inmates on the move (moving 146). This visual aid allows a user to quickly identify which inmates are out of their tier and which inmates are currently moving from one location to another. The locator icon 148 underneath the name of the inmate identifies the active location of that inmate. If an inmate is leaving the tier, a user can easily update that inmate's status by clicking on the locator icon 148, which will bring up a series of locator icons 148 to select from, as illustrated in FIG. 24. The user can select the locator icon 148 that relates to the specific inmates activity, whether in the tier, moving or out of the cell. One example of a locator icon 148 is a client transport. A user can indicate that the client is in transport from one location to another. GPS tracking can be used to monitor the location of the user's device or the inmate themselves. It is in this manner that the program can associate that metadata with the task including the route taken, time and date of transport. All of this inputted data will be recorded as a note 76 and will be viewable on note page (FIG. 21). The reader will appreciate that all known automatically collected data can be associated with any known user for comprehensive information.

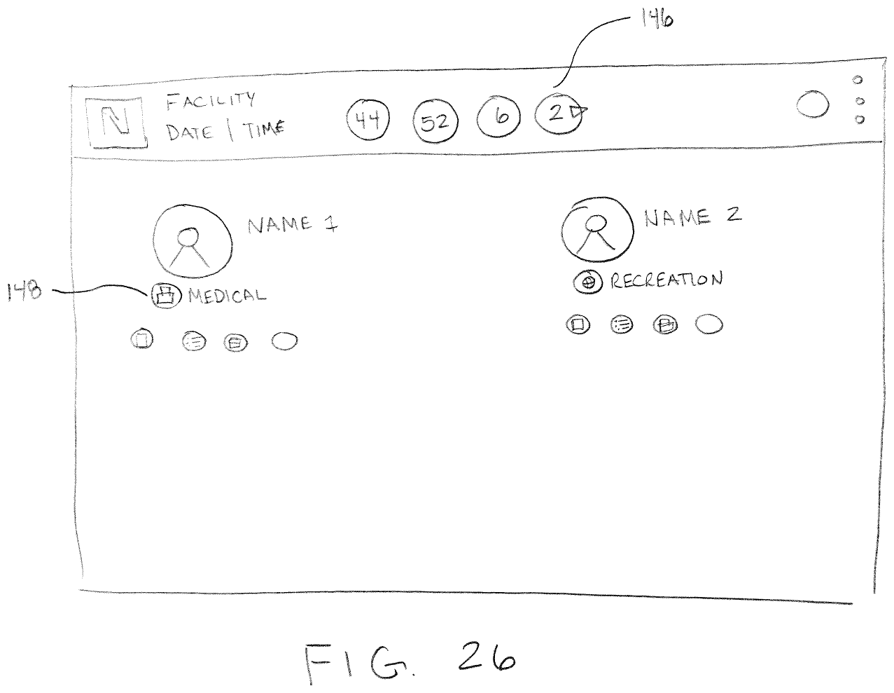

To easily view, which specific inmates are in the tier, out of the tier or on the move, the user can client on tier 140, out 144 or moving 146. If a user clicks on moving 146 (the broken circle), the user interface displays users on the move, as shown in FIG. 26. The user can quickly see the inmates on the move and easily visualize where each user is by viewing the locator icon 148 under their name. Further information can be inputted and provided under each inmate's name. The forms icon 94 can be used to access forms discussed herein (also accessible from the note page). If a user needs to complete a form for the particular inmate, the user can open the form by selecting the form icon 94 underneath that inmate's name. Once the appropriate form is selected from the list of available forms, the form will be automatically associated with that inmate. The required form information can be inputted by the user and the information will be attached to not only the inmate (as viewable on the client page) but also as a note 76 on the note page. The task icon 116 can also be selected under the inmate's name. Once selected, the user can add a recurring task specifically for that specific inmate. For example, that inmate may require a suicide watch. The user can set that up through the client page directly for that specific inmate. Finally, the user can select the medical icon 152 under the inmate's name. Once selected, the user will be able to view available notes relating to medical information for that specific inmate. Each inmate may also have additional important information underneath each inmate's name, such as whether the client has allergies or work detail.

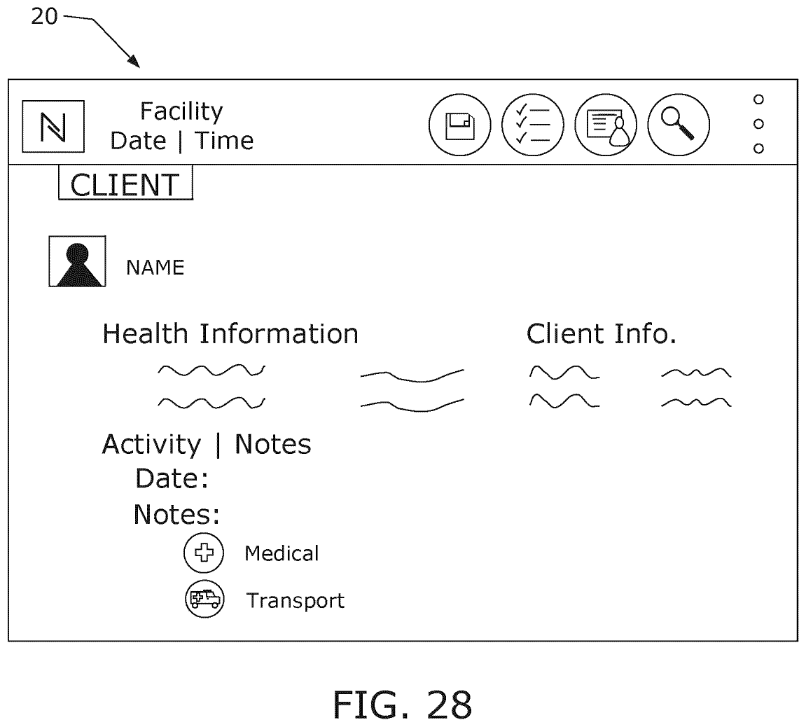

Each client can be clicked on to open the individual client's page (shown in FIG. 28). An administrator can update certain biographical information about a person being monitored, including their picture, name, date of birth, phone number, address, and the like. The administrator can also enter internal information about the person, including their room number and status at the facility, health information, medication, height, weight, eye color, hair color, and the like. This page allows a user to enter and view pertinent information about persons being monitored, allowing for accuracy when identifying a person at the facility as well as providing the user with a database of all information of a person being monitored. For example, the summary below an individual in FIG. 24 may show that the client has an allergy or work detail—it is in this manner that the pertinent information may be better processed by the administrator or user and remembered.

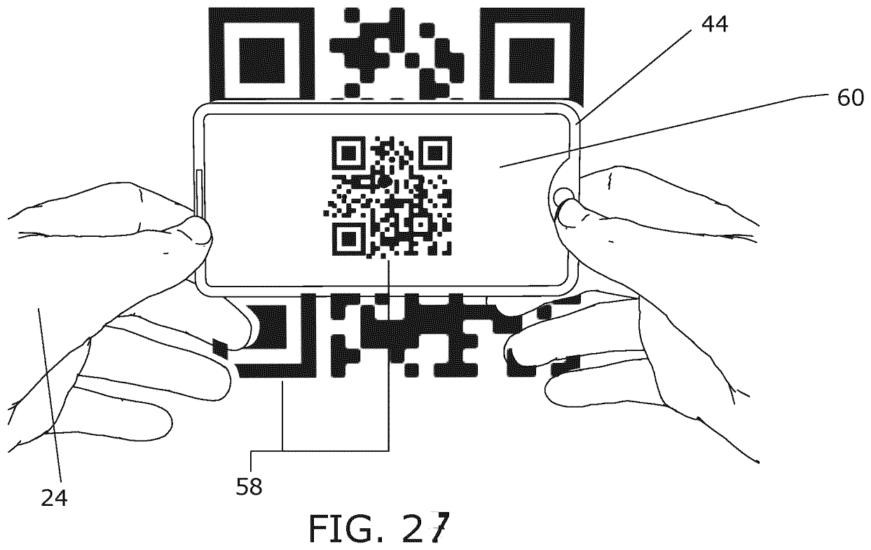

The present system has a number of input devices that are used around the facility to gather information. As an example of an input device, FIG. 27 illustrates a scanning process of the present invention. Mobile device 44 includes a digital camera (facing away from user and towards QR code 58 in FIG. 21). User 24 opens computer program product 20 (not shown) on his or her mobile device 44 and aims the device at the QR code 58 displayed at a given facility. An image of QR code 58 appears on display 60. Then, user 24 captures a depiction of QR code 58. Software running on mobile device 44 confirms the suitability of the image. The image of QR code 58 is temporarily stored. Application software running on mobile device 44 may then be used to recognize the characters contained within the image, and QR code 58 may then be stored as a simple character sequence. Additionally, a QR scanner can be located when an individual enters a room. That QR scanner can be connected wirelessly to a server for the collection of data from individuals scanning a QR code when they enter a room.

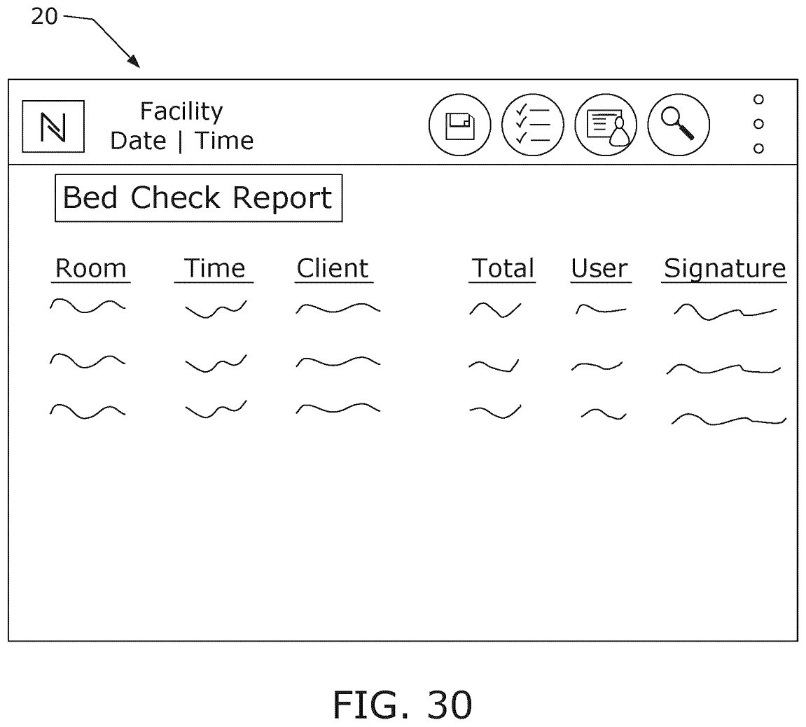

While a QR code is used to depict the scanning process of the present system and method in FIG. 27, the reader will appreciate that the same method can be used for input devices, such as biometric scanners (fingerprint, eye scans, facial recognition, or manual tagging). It is through this scanning process that a user or client location can be tracked throughout the facility. The input devices themselves can be linked to the computer program product and/or the mobile device collecting the input can be running the program. This same scanning process may be used to passively track any persons (clients) whose information is being inputted into the present system and method by a user or being collected by an input device. In the event a user is using the scanning mechanism while offline, the present system and method will automatically revert to the use of a PIN code, allowing the user to still attach the picture captured by the digital camera of mobile device 44 so that there is stored record of such location tracking in the case of an audit. Returning to FIG. 28, the client information, including the location passively and actively gathered through these input devices or user input. The information may be stored on the client page. The location of the client will be shown alongside all information about the client (health information, tasks or notes) completed involving the client. This view can also show a timeline of the client throughout the day, including all activities tagged to the client. Additionally, a report can be run for any given task. FIG. 30 illustrates a bed check report. The date and time each bed check was performed, as well as the room, the individuals' names, and the total number of individuals identified in each room at the date and time.

As previously described, FIG. 21 allows the user to begin the process of taking a note 76 by clicking on a row on the graphical user interface 20. The time auto-populates, and the user can select from a number of different icons, such as the active note icon 86 or the location icon 90, or in this case the forms icon 94. The forms are a feature that allows users to complete and connect forms to notes. Forms can be added as a separate note or after an active note has been created. Once the user selects the form icon 94, the user will open a separate window with a series of forms. The user can search for the appropriate form or scroll through the forms to find the correct form for the situation. When selected, the user can complete the form easily to attach to the note. For example, the user could select an intake form. Intake form would open on the screen for the user to complete required information and submit to save the form. Once added, the form will be associated with the note 76. Further, each time a form is changed, a new note 76 is added with the updated form, and the old form and note are archived. When this occurs, each note 76 requires a new signature so that auditing details are maintained.

An attachment review icon 112 will be displayed on the note 76, as shown in FIG. 18. The form may be easily opened for viewing or reference by tapping on the attachment review icon 112. Notes 76 can also be highlighted—again, this can be accomplished by selecting the highlighter icon 102, shown in FIG. 21. Once highlighted, the note 76 will be highlighted and appears on the screen as highlighted when viewing the list of notes 76. Further, notes 76 can be tagged with a comment or saved note by selecting the comment icon 98. Finally, notes 76 can be struck through by selecting the strikethrough icon 136.

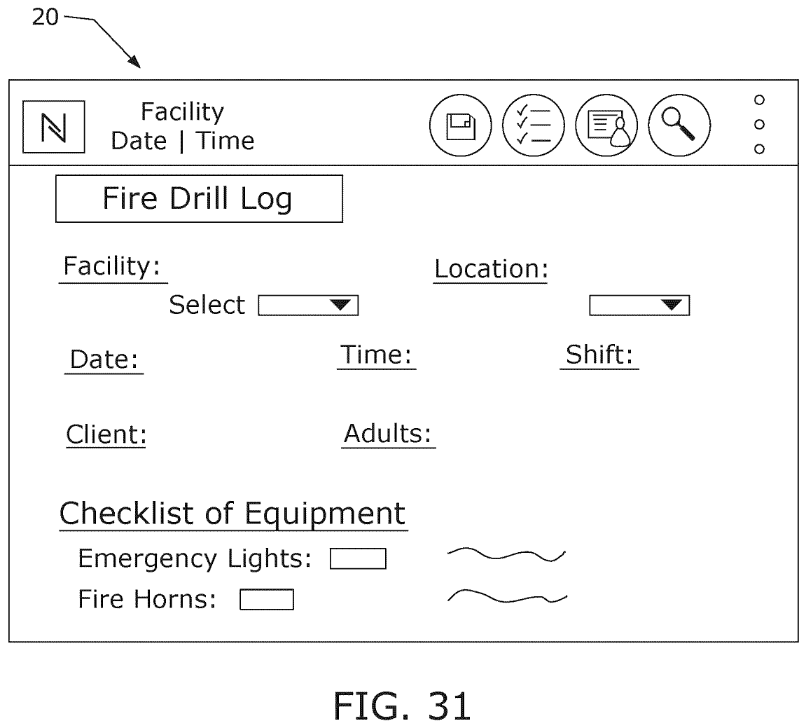

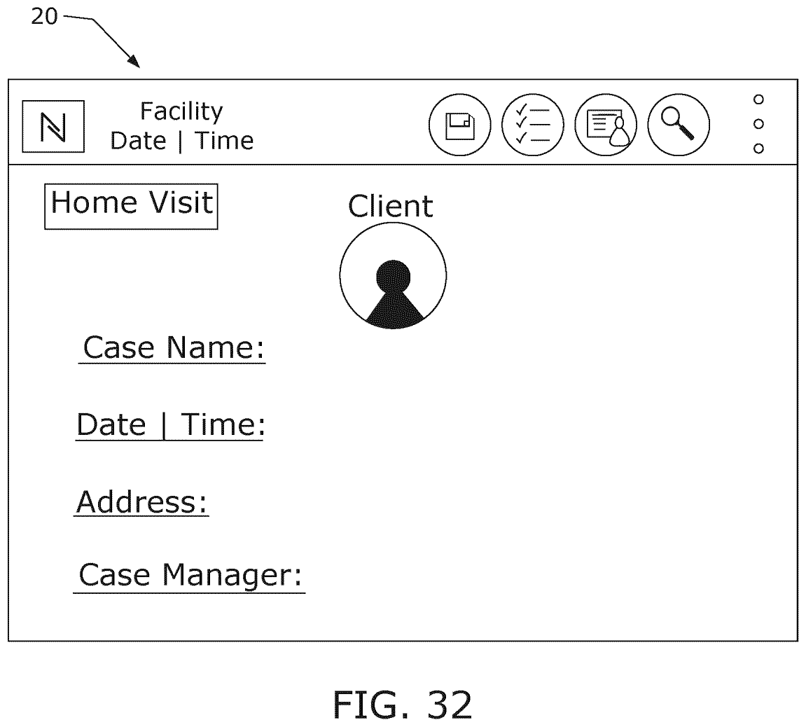

As an example, a user can complete the form in a required fire drill log, shown in FIG. 31. The user can easily enter the necessary details about the fire drill. The form includes drop down menus to provide efficiency and required fields to ensure the form is created quickly and accurately. The user is also able to include the date time, shift, etc. that the fire drill was performed. This information is useful in providing the safest facility possible while also including important information about when the drill was performed and by which user in case such information is necessary in the future. If these forms are mandated by a regulation or law, the ease and information already provided on the form will assist in compliance. Once complete, the form is attached to or visible as a note 76. An administrator can query the system for all fire drill logs created between specific dates to easily reply to an inquiry by an outside organization for purposes of compliance. Another example of a form is illustrated in FIG. 32, which depicts a home visit form, which may or may not be applicable depending on the facility implementing the present system and method. This form allows a user to track the case, date, placement address, time of home visit, and other identifying information. The form provides a streamlined place to enter imperative information regarding a home visit, such that a user may have more time and focus on the home visit at hand. Thus, this form provides a safe, secure, easily accessible place in which the user may store information out on the field and revisit the same information later.

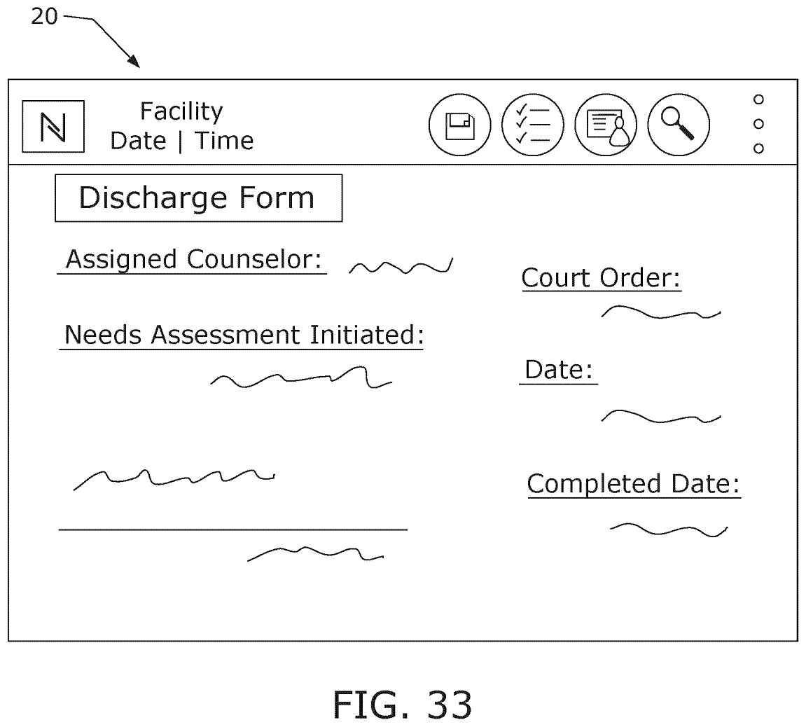

FIG. 33 depicts a discharge form. Again, this form provides a place for imperative information that a user will input about an individual being monitored. The form provides for very specific questions, such as whether the participant is from a military family, ensuring the most detailed and accurate information is stored on computer program product 20.

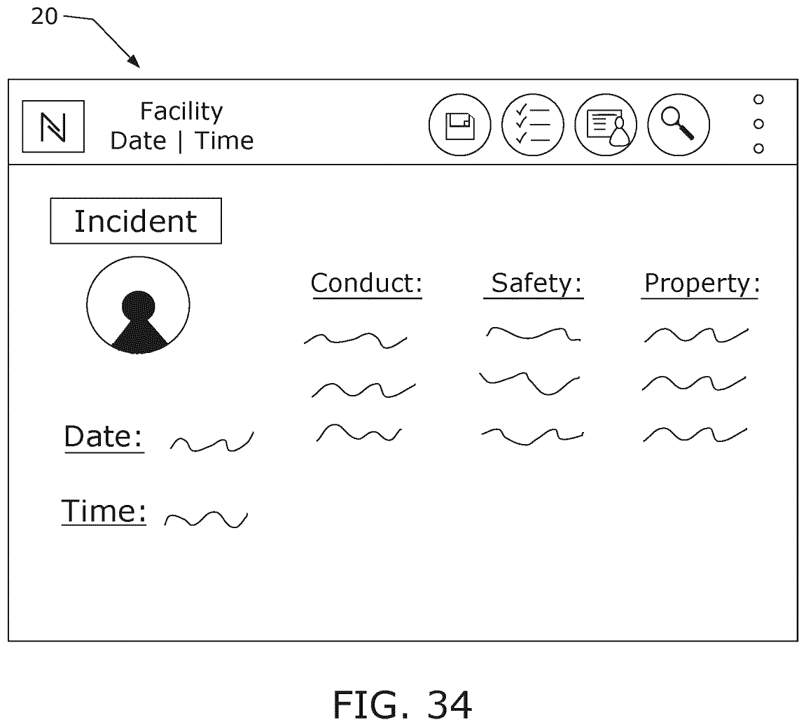

FIG. 34 depicts an incident form, allowing a user to document information about an incident that may occur at the facility. For example, the form allows a user to document whether there was “on-duty staff aggression” by a staff member or “property destruction” by an individual being monitored. This form is advantageous to a user because it allows a user to document behavior, and therefore patterns, regarding an individual being monitored, allowing for greater efficiency and an improved database. Users, locations and facilities can be linked to incident forms. Additionally, any passively collected data can be linked to the form (or note 76 that the form is attached to). Reports can be run to view specific incident forms.

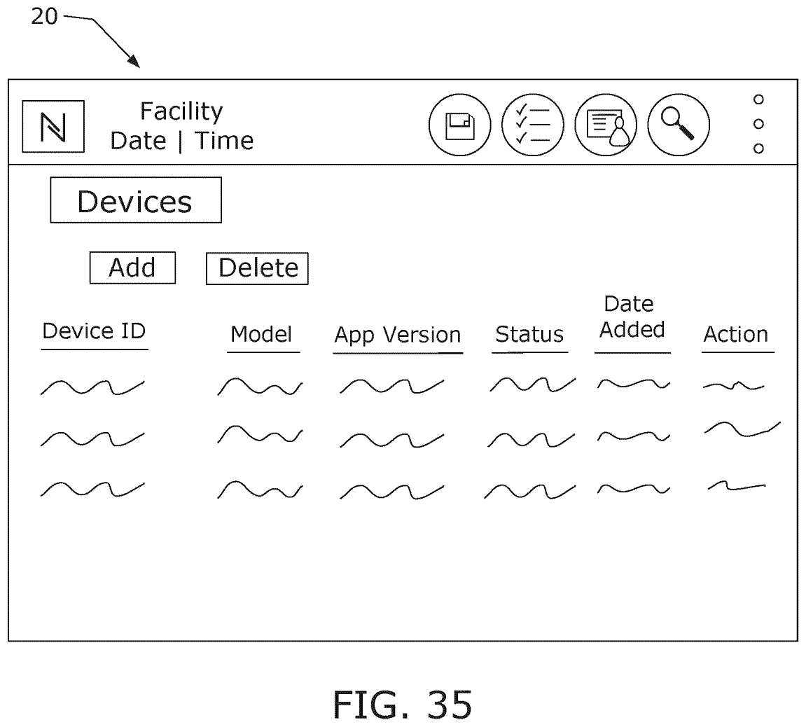

Administrative control is a key feature of the computer program product 20. It allows the administrator to easily control what data is entered and how it is entered, along with providing oversight of the devices, facilities and users. FIG. 35 displays graphical user interface showing a device page. This figure depicts another master facility view, in which a facility may monitor what devices are using computer program product 20. Each device has an identification number, allowing for ease of identification of any particular device when necessary.

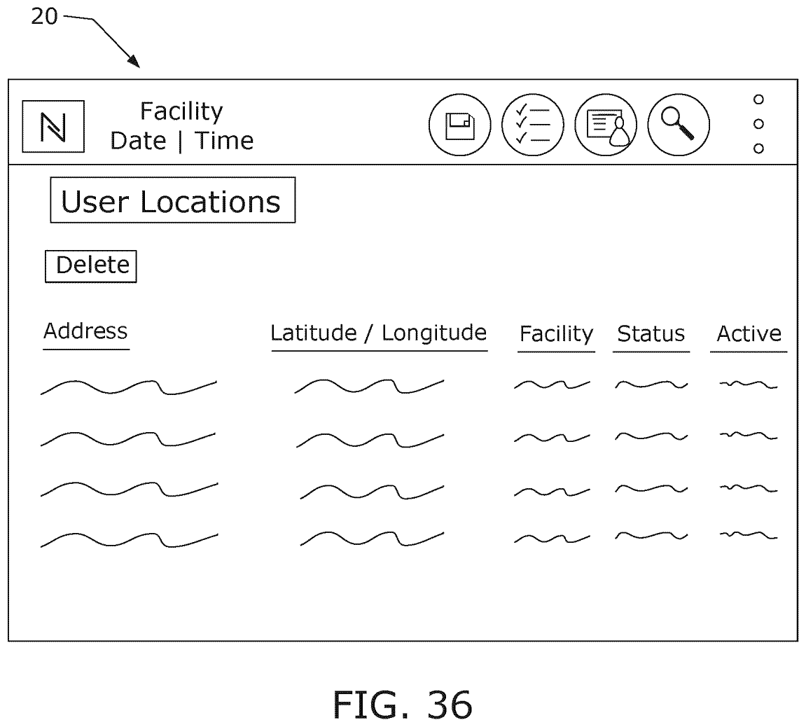

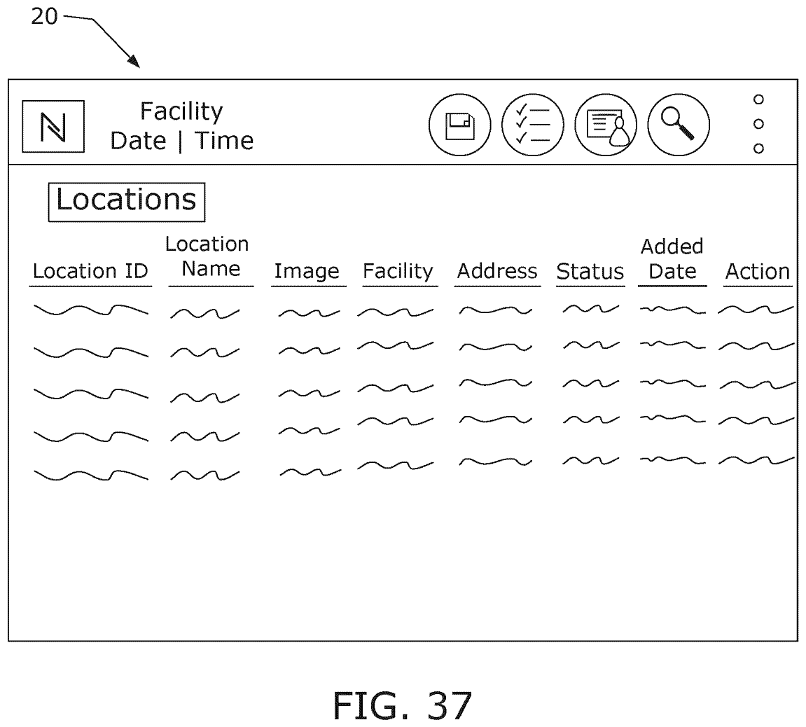

FIG. 36 illustrate a view that an administrator can access to view the location of various users. In other words, the active location of various users of computer program product 20 can be seen at any time. FIG. 37 provides for the location of various facilities that are using computer program product 20. Again, these views are displayed for administrators, rather than users of the present system and method.

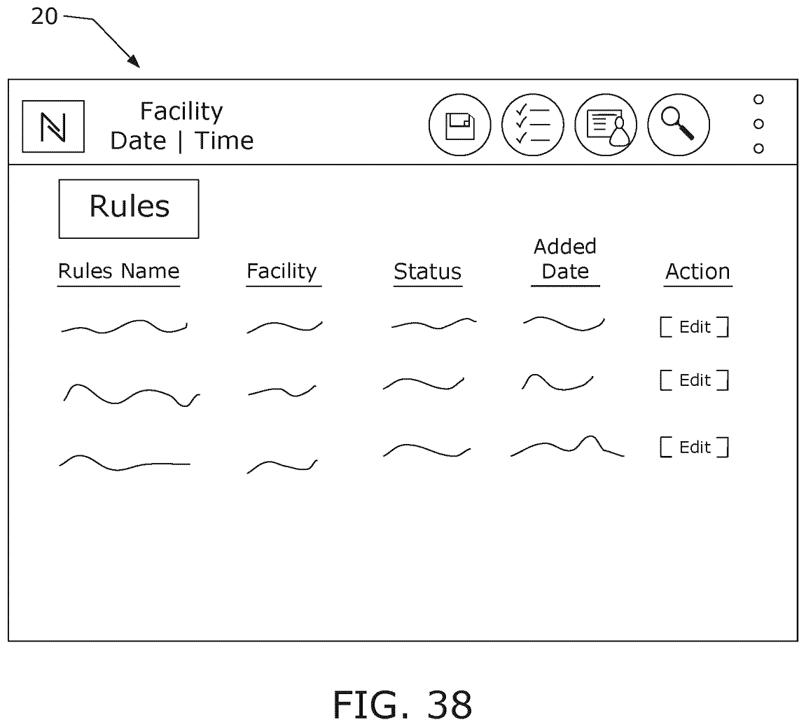

FIG. 38 illustrates the rules page. Each rule 78 has a name, facility, status, and date associated with it. Actions associated with rules can be edited. The user can create workflows like tasks from the rules that trigger entering a form required by a certain time frame, including initiating alerts. The alerts can be sent in any method, such a SMS or e-mail alert. Rules can also trigger additional rules or workflows.

The present system and method provides many advantages over previous methods. For example, all data is tracked in a central database(s) or other storage medium so that the data is aggregated and can be used in a manner to provide graphical representations of the persons being observed/assessed. Further, biometric assistance is available for user log in. GPS tracking provides location monitoring to persons being transported. The user can use different active notes and attach metadata into these digital notes, as well as the ability to copy and share their notes. A master facility view is available such that a facility is better able to aggregate all information compiled from their many users. Field security is also available with encryption, which may include privacy and compliance requirements. A visual history of individuals being monitored is available on the present system via tagging functionality, which may be done automatically using facial recognition or through manual tagging. SMS and e-mail alerts and notifications are available to alert the user of a required activity. The ability to create tasks with attachments and approvals is also available. Information may be shared from the user's device to other users on the system, which is pin and/or password protected. A user also can print forms and information using a defined form.

The preceding description contains significant detail regarding the novel aspects of the present invention. It should not be construed, however, as limiting the scope of the invention but rather as providing illustrations of the preferred embodiments of the invention.

Having described my invention, I claim:

1. A computer-implemented method in a server system for executing computer readable program code for a method of electronically tracking data associated with at least one observed individual for use in a controlled environment, wherein said method includes a user and at least one administrator:
providing said computer readable program code on said server system adapted to execute a set of instructions to display a graphical user interface;
providing a computing device having a screen to said user wherein said graphical user interface is displayed;
wherein said user is able to enter a first set of data associated with said at least one observed individual into said computing device;
wherein said user enters said first set of data by selecting an entry line and beginning a note;
wherein said user can select from a series of icons to take action to enter said first set of data;
wherein said series of icons includes at least a note icon to begin a first active note;
wherein when said user selects said note icon, said graphical user interface displays a series of tasks to select from to begin entering said first set of data in response to a first task;
wherein said user selects from said series of tasks and said graphical user interface prompts said user to input said first set of data related to said first task;
wherein said administrator configures said first task to require a set of specific information in a series of fields as said first set of data;
wherein said user verifies said first set of data and submits said first set of data to said server system;
wherein said computing device communicates with said server system via a communications link to submit said first set of data; and
wherein said computing device displays said first active note in a list on said graphical user interface;
providing at least one input device within said controlled environment to collect a second set of data in an ongoing passive manner;
collecting said second set of data using said at least one input device and associating said second set of data with said first active note; and
submitting said second set of data to said server system.

2. The computer-implemented method of claim 1, wherein said series of fields are configured to relate to a series of standards.

3. The computer-implemented method of claim 1, wherein said user can select from a series of forms and said graphical user interface prompts said user to input said first set of data related to a required form; and wherein said required form can be attached to said note.

4. The computer-implemented method of claim 1, wherein said at least one input device is a microphone.

5. The computer-implemented method of claim 1, wherein said at least one input device is a video camera.

6. The computer-implemented method of claim 1, wherein said at least one input device is a mobile computing device.

7. The computer-implemented method of claim 1, wherein said at least one input device is a QR code reader.

8. The computer-implemented method of claim 1, wherein said at least one input device is a temperature sensor.

9. The computer-implemented method of claim 1, wherein said at least one input device is a smartwatch.

10. A computer-implemented method in a server system for executing computer readable program code for a method of electronically tracking data associated with at least one observed individual for use in a controlled environment, wherein said method includes a user and at least one administrator:
providing said computer readable program code on said server system adapted to execute a set of instructions to display a graphical user interface;
providing a computing device having a screen to said user wherein said graphical user interface is displayed;
wherein said user is able to enter a first set of data associated with said at least one observed individual into said computing device;
wherein said user enters said first set of data by selecting an entry line and beginning a note;
wherein said user can select from a series of icons to take action to enter said first set of data;
wherein said series of icons includes at least a note icon, a forms icon and a roster icon;
wherein if said user selects said note icon, said graphical user interface displays a series of tasks for said user to select from to begin an active note;
wherein when said user begins an active note, said user is prompted to enter a set of required fields thereby compiling said first set of data;
wherein said user verifies said first set of data and submits said first set of data to said server system;
wherein if said user selects said forms icon, said graphical user interface displays a series of forms;
wherein when said user selects a form from said series of forms, a series of entry fields relating to said form is displayed on said graphical user interface;
wherein said user completes said form with said first set of data and attaches said form to said note;
wherein said note is compiled in a series of notes in a list shown on said graphical user interface;
wherein if said user selects said roster icon, said graphical user interface displays a list of a plurality of observed individuals, a summary of a number of said plurality of observed individuals in an enclosed location, out of said enclosed location or on the move from or to said enclosed location;
wherein said user can update said summary and said location of said observed individual by selecting an icon beneath said observed individual;
wherein said location will be updated and a note will be automatically created and added to said list of said series of said notes;
wherein said computing device communicates with said server system via a communications link to submit said first set of data; and
providing at least one input device within said controlled environment to collect a second set of data in an ongoing passive manner;
collecting said second set of data using said at least one input device and associating said second set of data with said first active note; and
submitting said second set of data to said server system.

11. The computer-implemented method of claim 10, wherein said series of fields are configured to relate to a series of standards.

12. The computer-implemented method of claim 10, wherein said user can select from a series of forms and said graphical user interface prompts said user to input said first set of data related to a required form; and wherein said required form can be attached to said note.

13. The computer-implemented method of claim 10, wherein said at least one input device is a microphone.

14. The computer-implemented method of claim 10, wherein said at least one input device is a video camera.

15. The computer-implemented method of claim 10, wherein said at least one input device is a mobile computing device.

16. The computer-implemented method of claim 10, wherein said at least one input device is a QR code reader.

17. The computer-implemented method of claim 10, wherein said at least one input device is a temperature sensor.

18. The computer-implemented method of claim 10, wherein said at least one input device is a smartwatch.
